(19) United States
(12) Patent Application Publication
(10) Pub. No.: US 2023/0418694 A1
(43) Pub. Date: Dec. 28, 2023

(54) ELECTRONIC DEVICE AND CLIPBOARD OPERATION METHOD THEREOF

(71) Applicant: Samsung Electronics Co., Ltd., Suwon-si (KR)

(72) Inventors: Youngjae MEEN, Suwon-si (KR); Jaehyun HAN, Suwon-si (KR); Younghak OH, Suwon-si (KR)

(21) Appl. No.: 18/463,675

(22) Filed: Sep. 8, 2023

Related U.S. Application Data
(63) Continuation of application No. PCT/KR2022/003318, filed on Mar. 8, 2022.

(30) Foreign Application Priority Data
Mar. 9, 2021 (KR) 10-2021-0030907

(51) Int. Cl. G06F 9/54; G06F 9/451

(52) U.S. Cl. CPC G06F 9/543; G06F 9/451

(57) ABSTRACT

An electronic device and/or a clipboard operation method thereof. An electronic device may include a display module, a memory and a processor. The processor may: while an execution screen of an application is displayed, detect a first user input for a clip of specified content; on the basis of the first user input, generate clip data including contextual information and a clip object associated with the content, and store same in the memory; detect a second user input related to calling a clipboard; on the basis of the detection of the second user input, analyze a task that is currently being carried out on the electronic device; call the clipboard on the basis of the detection of the second user input; extract clip data corresponding to the task, among a plurality of clip data of the clipboard; and provide, through the display module, a clipboard which is based on the clip data corresponding to the task. Various embodiments are possible.

### CROSS-REFERENCE TO RELATED APPLICATIONS

This application is a continuation of International Application No. PCT/KR2022/003318 filed on Mar. 8, 2022, designating the United States, in the Korean Intellectual Property Receiving Office, and claiming priority to KR Patent Application No. 10-2021-0030907 filed on Mar. 9, 2021, in the Korean Intellectual Property Office, the disclosures of all of which are hereby incorporated by reference herein in their entireties.

### BACKGROUND

### Field

Certain example embodiments disclose an electronic device and/or a method for operating a clipboard in the electronic device.

### Description of Related Art

With the development of digital technology, various types of electronic devices such as personal digital assistants (PDAs), electronic notepads, smartphones, tablet personal computers (PCs), wearable devices, digital cameras, laptop PCs, and/or desktop PCs are widely used. These electronic devices are continuously being developed in terms of their hardware and/or software components to support and enhance their functionalities. For example, electronic devices can be equipped with various functions such as an Internet function, a messenger function, a document function, an email function, an electronic notepad function, a schedule management function, a messaging function, and/or a media playback function.

Generally, in electronic devices, multiple applications (or apps) related to various functions may be installed, and a corresponding function may be provided through execution of each application. These electronic devices support a clipboard function capable of copying and pasting predetermined data from an execution screen of an executed application.

However, the clipboard function in the conventional electronic devices supports only simple functions such as copying and pasting data. For example, the conventional electronic devices support only simple functions which allow users to copy designated data from a screen containing source data of the electronic device, and then to paste the copied data through a screen conversion to a screen to which data is to be pasted within the electronic device.

In addition, the clipboard function in the conventional electronic devices may store only data (e.g., content such as text or image) designated and copied by a user, and paste only the data itself.

### SUMMARY

In various example embodiments, a method and/or an apparatus capable of storing and utilizing contextual information (or contextual data) of a clip object (or content) together with a content-based clip object when clip data related to designated content is generated on the execution screen of an application in an electronic device are disclosed.

In various example embodiments, a method and/or an apparatus capable of identifying, when a clipboard is called in an electronic device, a task currently being performed (or user intention or action) in the electronic device and providing a clipboard based on a recommendation of a clip object optimized for the currently performed task are disclosed.

In various example embodiments, a method and/or an apparatus capable of sharing (or synchronizing) clip data including clip objects and contextual information generated in an electronic device and supporting a user to perform consecutive tasks in the electronic device or other electronic devices of the user are disclosed.

In various example embodiments, a method and/or an apparatus capable of calling, when a clip object is selected from a clipboard of an electronic device, clip data (e.g., a clip object and/or contextual information related to the clip object) of the clip object so that a user can continue to perform a previously performed task based on the clip data are disclosed.

An electronic device according to an example embodiment may include a display module, a memory, and a processor operatively connected, directly or indirectly, to the display module and the memory, wherein the processor may be configured to detect a first user input for a clip of designated content while displaying an execution screen of an application, to generate clip data including a clip object and contextual information related to the content based on the first user input and store the generated clip data in the memory, to detect a second user input related to calling a clipboard, to analyze a task currently being performed in the electronic device based on the detection of the second user input, to call the clipboard based on the detection of the second user input, to extract clip data corresponding to the task from a plurality of pieces of clip data of the clipboard, and to provide the clipboard based on the clip data corresponding to the task through the display module.

An operating method of an electronic device according to an example embodiment may include detecting a first user input for a clip of designated content while displaying an execution screen of an application, generating clip data including a clip object and contextual information related to the content based on the first user input and storing the generated clip data in a memory, detecting a second user input related to a clipboard call, analyzing a task currently being performed in the electronic device based on the detection of the second user input, calling a clipboard based on the detection of the second user input, extracting clip data corresponding to the task from among a plurality of pieces of clip data of the clipboard, and providing a clipboard based on the clip data corresponding to the task through a display module.

In various example embodiments to solve the above problems, a computer-readable recording medium in which a program for executing the method in a processor is recorded may be included.

The additional scope of applicability of the disclosure will become apparent from the detailed description provided below. However, since various changes and modifications within the spirit and scope of the disclosure can be clearly understood by those skilled in the art, it should be understood that the detailed description and specific embodiments such as the preferred example embodiments are given as illustrative examples only.

According to an electronic device and/or an operating method thereof according to an example embodiment, when a designated area, object, and/or group for various types of content are selected and copied in an electronic device and the selected and copied data is stored on a clipboard, a content-based clip object and contextual information of the clip object (or content) may be stored together, and based on this, accessibility and convenience for the user's use of the clipboard may be improved.

According to an example embodiment, when a user calls a clipboard in an electronic device, based on a task currently being performed (or user intention or action) in the electronic device, a clip object optimized for the currently performed task (or user situation) may be preferentially recommended and provided. According to an example embodiment, an electronic device may share (or synchronize) clip data including a clip object and contextual information, and a user may perform a task consecutive to a previously performed task by using the clip data in the electronic device or other electronic devices of the user, thereby increasing user convenience.

Additionally, various effects identified directly or indirectly through this document may be provided.

### BRIEF DESCRIPTION OF DRAWINGS

The above and other aspects, features and advantages of certain embodiments of the present disclosure will be more apparent from the following detailed description, taken in conjunction with the accompanying drawings, in which:

In the description of the drawings, the same or similar reference numerals may be used for the same or similar elements.

FIG. 1 is a block diagram illustrating an example electronic device in a network environment according to various example embodiments.

FIG. 2 is a diagram schematically illustrating a configuration of an electronic device according to various example embodiments.

FIG. 3 is a flowchart illustrating an operating method of an electronic device according to various example embodiments.

FIG. 4 is a flowchart illustrating an operating method of an electronic device according to various example embodiments.

FIG. 5 is a diagram illustrating an example of a clip of content and clip data generated according to the clip in an electronic device according to various example embodiments.

FIG. 6 is a diagram illustrating an example of operating a clipboard according to various example embodiments.

FIG. 7 is a flowchart illustrating an operating method of an electronic device according to various example embodiments.

FIG. 8 is a diagram illustrating an example of providing clip data of a clipboard in an electronic device according to various example embodiments.

FIG. 9 is a diagram illustrating another example of providing clip data of a clipboard in an electronic device according to various example embodiments.

FIG. 10A is a diagram illustrating another example of providing clip data of a clipboard in an electronic device according to various example embodiments.

FIG. 10B is a diagram illustrating another example of providing clip data of a clipboard in an electronic device according to various example embodiments.

FIG. 10C is a diagram illustrating another example of providing clip data of a clipboard in an electronic device according to various example embodiments.

FIG. 11 is a diagram illustrating another example of providing clip data of a clipboard in an electronic device according to various example embodiments.

FIG. 12 is a diagram illustrating another example of providing clip data of a clipboard in an electronic device according to various example embodiments.

FIG. 13 is a diagram illustrating another example of providing clip data of a clipboard in an electronic device according to various example embodiments.

FIG. 14 is a diagram illustrating another example of providing clip data of a clipboard in an electronic device according to various example embodiments.

FIG. 15 is a flowchart illustrating an operating method of an electronic device according to various example embodiments.

FIG. 16A is a diagram illustrating an example of providing a clipboard in an electronic device according to various example embodiments.

FIG. 16B is a diagram illustrating an example of providing a clipboard in an electronic device according to various example embodiments.

FIG. 17 is a flowchart illustrating an operating method of an electronic device according to various example embodiments.

FIG. 18 is a diagram illustrating an example of providing a clipboard in an electronic device according to various example embodiments.

FIG. 19 is a flowchart illustrating an operating method of an electronic device according to various example embodiments.

FIG. 20A is a diagram illustrating an example of providing a clipboard in an electronic device according to various example embodiments.

FIG. 20B is a diagram illustrating an example of providing a clipboard in an electronic device according to various example embodiments.

FIG. 21A is a diagram illustrating an example of providing a clipboard in an electronic device according to various example embodiments.

FIG. 21B is a diagram illustrating an example of providing a clipboard in an electronic device according to various example embodiments.

FIG. 22 is a flowchart illustrating an operating method of an electronic device according to various example embodiments.

FIG. 23A is a diagram illustrating an example of providing a clipboard in an electronic device according to various example embodiments.

FIG. 23B is a diagram illustrating an example of providing a clipboard in an electronic device according to various example embodiments.

FIG. 24 is a diagram illustrating an example of configuring a synchronization target of a clipboard in an electronic device according to various example embodiments.

FIG. 25 is a flowchart illustrating an operating method of an electronic device according to various example embodiments.

FIG. 26 is a diagram illustrating an example of utilizing clip data of a clipboard in an electronic device according to various example embodiments.

FIG. 27 is a flowchart illustrating an operating method of an electronic device according to various example embodiments.

FIG. 28 is a diagram illustrating an example of operating clip data of a clipboard in an electronic device according to various example embodiments.

FIG. 29 is a diagram illustrating an example of operating clip data of a clipboard in an electronic device according to various example embodiments.

FIG. 30 is a flowchart illustrating an operating method of an electronic device according to various example embodiments.

FIG. 31 is a flowchart illustrating an operating method of an electronic device according to various example embodiments.

FIG. 32 is a diagram illustrating an example of executing clip data in an electronic device according to various example embodiments.

FIG. 33 is a diagram illustrating an example of utilizing clip data of a clipboard in an electronic device according to various example embodiments.

### DETAILED DESCRIPTION

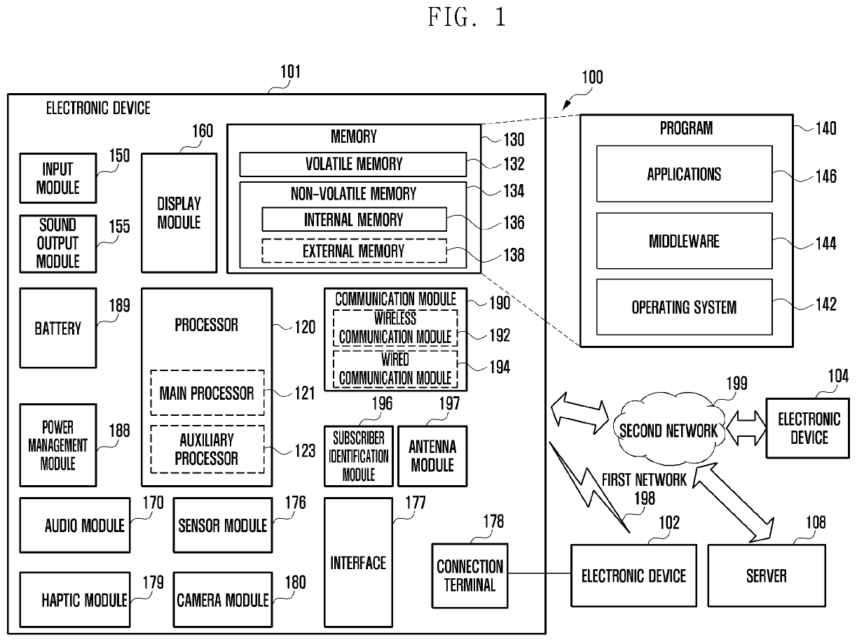

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an example embodiment, the electronic devices are not limited to those described above.

It should be appreciated that various example embodiments and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s).

As used in connection with various example embodiments, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various example embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

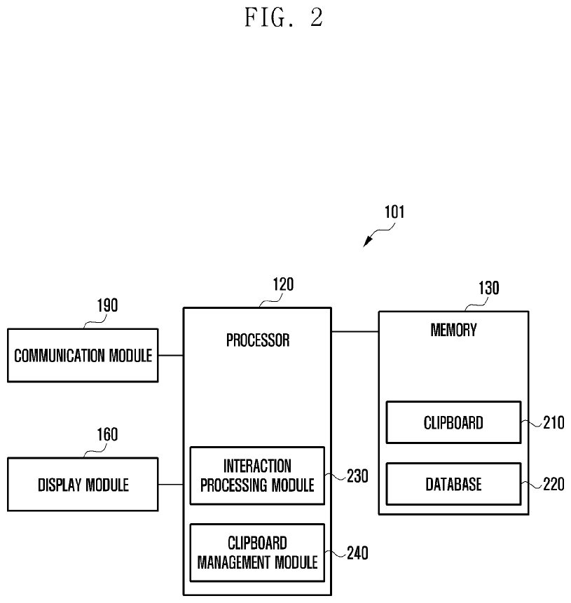

FIG. 2 is a diagram schematically illustrating a configuration of an electronic device according to various embodiments.

Referring to FIG. 2, an electronic device 101 according to an embodiment may include a communication module 190 comprising communication circuitry, a display module 160 comprising a display, a processor 120, and a memory 130.

According to an embodiment, the communication module 190 may correspond to the communication module 190 as described with reference to FIG. 1. According to an embodiment, the communication module 190 may support a legacy network (e.g., 3G network and/or 4G network), 5G network, out of band (OOB), and/or next-generation communication technology (e.g., new radio {NR} technology). According to an embodiment, the communication module 190 may correspond to the wireless communication module 192 as illustrated in FIG. 1.

According to an embodiment, the electronic device 101 may use the communication module 190 to perform communication with an external electronic device (e.g., the server 108 {e.g., cloud} and/or other electronic devices 102 and 104 in FIG. 1) through a network. According to an embodiment, when generating (or storing) clip data in a clipboard, the electronic device 101 may transmit corresponding clip data to a server through the communication module 190 so that clip data may be shared (or synchronized) in a clipboard of a server (e.g., cloud).

According to an embodiment, the display module 160 may correspond to the display module 160 as described with reference to FIG. 1. According to an embodiment, the display module 160 may visually provide various types of information to the outside (e.g., a user) of the electronic device 101. According to an embodiment, the display module 160 may include a touch sensing circuit (or a touch sensor) (not shown), a pressure sensor capable of measuring the strength of a touch, and/or a touch panel (e.g., a digitizer) for detecting a magnetic stylus pen.

According to an embodiment, the display module 160 may detect a touch input and/or a hovering input (or a proximity input) by measuring a change in a signal (e.g., light quantity, resistance, electromagnetic signal and/or charge quantity) with respect to a specific position of the display module 160 based on the touch sensing circuit, the pressure sensor, and/or the touch panel. According to an embodiment, the display module 160 may include a liquid crystal display (LCD), an organic light emitted diode (OLED), or an active matrix organic light emitted diode (AMOLED). According to some embodiments, the display module 160 may include a flexible display.

According to an embodiment, the display module 160 may visually provide various screens such as an interface related to an application, an interface related to a clipboard, and/or an interface related to task processing using clip data, under the control of the processor 120. According to an embodiment, the display module 160 may display various types of information (e.g., a user interface) related to a clipboard and/or clip data of the clipboard.

According to an embodiment, the memory 130 may correspond to the memory 130 as described with reference to FIG. 1. According to an embodiment, the memory 130 may store various types of data used by the electronic device 101. The data may include, for example, input data or output data for an application (e.g., the program 140 of FIG. 1) and a command related thereto.

According to an embodiment, the memory 130 may include a clipboard 210 and a database 220 related to operating a clipboard function, which may be performed by the processor 120. According to an embodiment, the application may be an application (e.g., the clipboard 210) capable of using a clipboard function. According to an embodiment, the application (e.g., the clipboard 210) may be stored as software (e.g., the program 140 of FIG. 1) on the memory 130 and may be executable by the processor 120.

According to an embodiment, the clipboard function may be a function of supporting operations (e.g., a user interaction) such as cut, copy, and paste with respect to content designated by a user on the electronic device 101.

According to an embodiment, when capturing content (e.g. an operation of storing cut or copied content {e.g. clip data}), the data may include a content-based clip object and contextual information (or contextual data) of the clip object (or content), and the memory 130 may store and manage the clip object and the contextual information as clip data in the database 220.

According to an embodiment, the memory 130 may store at least one module for processing a clipboard function, which may be performed by the processor 120. For example, the memory 130 may include at least some of an interaction processing module 230 and/or a clipboard management module 240 in the form of software (or in the form of instructions).

According to an embodiment, the processor 120 may control an operation (or processing) related to operating the clipboard function in the electronic device 101. According to an embodiment, while displaying an execution screen of an application, the processor 120 may generate clip data related to content based on a first user input for a clip of designated content and may register (or update) the generated clip data in the clipboard 210.

According to an embodiment, clip data may include a clip object (e.g., a copy object) related to designated content and contextual information related to the clip object (or content). According to an embodiment, when generating clip data, the processor 120 may analyze (or identify or extract) contextual information such as a type of a clip object (or content), identification information (e.g., type, link {e.g., URL}, and/or name) of an application, a task being performed by an application, and/or a variety of contextual information (or time, place occasion {TPO} information) related to a user (or the electronic device 101) at the time of clipping operation, together with the clip object.

According to an embodiment, the processor 120 may map the contextual information and the clip object and may store them in the memory 130 as clip data. According to an embodiment, the processor 120 may store the clip object in the clipboard 210, and may store and manage the contextual information linked with the clip object of the clipboard 210 in the database 220 in the form of a lookup table.

According to an embodiment, the processor 120 may analyze a currently performed task based on a second user input for calling the clipboard 210. According to an embodiment, the processor 120 may analyze (or recognize) an application currently being executed in the electronic device 101 and/or a context (or a state) of a task currently being performed in the executed application, based on detection of a second user input. For example, the processor 120 may analyze a task-related context such as identification information (e.g., type, link {e.g., URL}, and/or name), a task being performed by an application, and/or a variety of contextual information (or TPO information) related to a user (or the electronic device 101) at the time of calling a clipboard. According to an embodiment, the processor 120 may understand the context of a current task through machine learning.

According to an embodiment, the processor 120 may call the clipboard 210 and extract clip data based on the detection of the second user input. According to an embodiment, the processor 120 may extract clip data corresponding to the analyzed task (or the context of the task) from a plurality of pieces of clip data of the clipboard 210 in an operation of calling the clipboard 210.

According to an embodiment, the processor 120 may provide (e.g., display) a clipboard based on clip data corresponding to the task. According to an embodiment, the processor 120 may provide the clipboard 210 including (or recommending) only clip data extracted in correspondence with the context of the task. According to an embodiment, the processor 120 may provide (e.g., display) a clipboard on an execution screen of an application through a designated area of the display module 160. For example, when providing the clipboard, the processor 120 may provide the clipboard by overlaying the clipboard on the execution screen, may provide the clipboard in a pop-up form by a pop-up window, or may provide the clipboard in a split area by a split window.

According to an embodiment, the processor 120 may include at least one module for processing a clipboard function. For example, the processor 120 may include an interaction processing module 230 and/or a clipboard management module 240.

According to an embodiment, the interaction processing module 230 may indicate a module that detects various user inputs related to operating a clipboard in the electronic device 101 and processes a function corresponding to a user input. According to an embodiment, the interaction processing module 230 may process functions according to various user inputs related to generating clip data of a clipboard, pasting clip data, moving clip data, sharing (or synchronizing) a clipboard, and/or sharing (or synchronizing) clip data.

According to an embodiment, the interaction processing module 230 may process a function of generating clip data including a clip object and contextual information based on a user input. According to an embodiment, an operation of the interaction processing module 230 will be described in detail with reference to drawings to be described later.

According to an embodiment, the clipboard management module 240 may indicate a module that identifies various user settings related to operation of a clipboard in the electronic device 101 and manages the clipboard based on the user settings. According to an embodiment, the clipboard management module 240 may process various operations related to sharing (or synchronization) based on policies related to the clipboard and/or clip data and collective or individual management of clip data based on the security level of the clip data, based on the user input related to the clipboard. According to an embodiment, an operation of the clipboard management module 240 will be described in detail with reference to the following drawings.

According to an embodiment, at least some of the interaction processing module 230 and/or the clipboard management module 240 may be included in the processor 120 as hardware modules (e.g., circuitry), and/or may be implemented as software including one or more instructions that can be executed by the processor 120. For example, operations performed by the processor 120 may be stored in the memory 130, and may be performed by instructions that cause the processor 120 to operate when executed.

According to various embodiments, the processor 120 may control various operations related to normal functions of the electronic device 101 in addition to the above functions. For example, the processor 120 may control its operation and screen display when a specific application is executed. For another example, the processor 120 may receive input signals corresponding to various touch events or proximity event inputs supported by a touch-based or proximity-based input interface, and may control function operation according to the input signal.

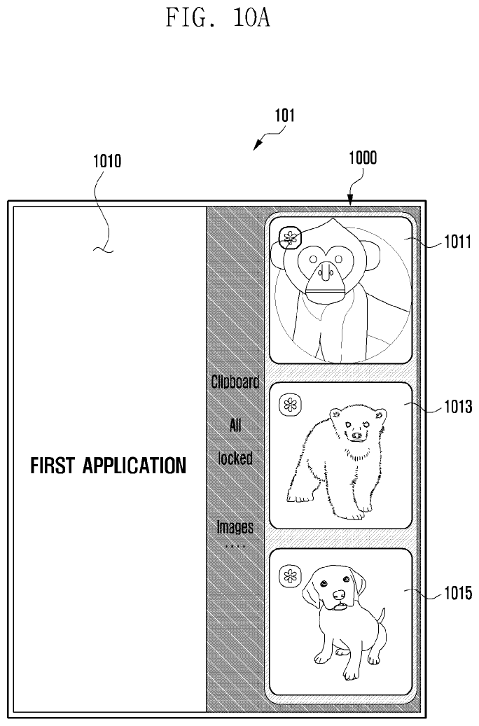

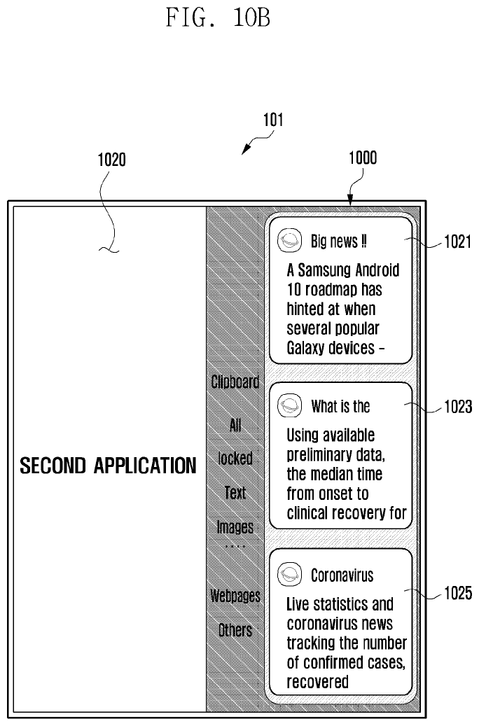

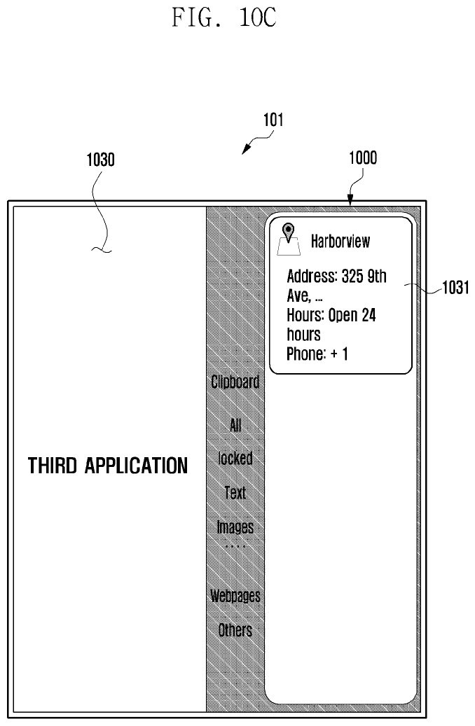

The electronic device 101 according to an example embodiment may include a display module 160 comprising a display, a memory 130, and a processor 120 operatively connected, directly or indirectly, to the display module 160 and the memory 130, wherein the processor 120 may be configured to detect a first user input for a clip of designated content while displaying an execution screen of an application, to generate clip data including a clip object and contextual information related to the content based on the first user input and store the generated clip data in the memory, to detect a second user input related to calling a clipboard 1000 (e.g., see clipboard 1000 in FIGS. 10-12, 14, 16, 18, 20-21, 23, 24, 26, 28-29, 32-33), to analyze a task currently being performed in the electronic device 101 based on the detection of the second user input, to call the clipboard 1000 based on the detection of the second user input, to extract clip data corresponding to the task from a plurality of pieces of clip data of the clipboard 1000, and to provide the clipboard 1000 based on the clip data corresponding to the task through the display module 160.

According to an example embodiment, the clip data may include the clip object related to designated content and the contextual information related to the clip object.

According to an example embodiment, the contextual information may include a type of the clip object, identification information of an application, a task being performed by the application, and/or contextual information related to a user at the time of clipping operation.

According to an example embodiment, the processor 120 may be configured to store the clip object in the clipboard 1000 of the memory, and may store and manage contextual information linked with the clip object in the form of a lookup table in a database of the memory.

According to an example embodiment, the processor 120 may be configured to analyze an application currently being executed in the electronic device 101 by machine learning and/or the context of a task being performed in the executed application, based on the detection of the second user input.

According to an example embodiment, the processor 120 may be configured to extract clip data based on contextual information corresponding to the context of the task, and to recommend the extracted clip data corresponding to the context of the task through the clipboard 1000.

According to an example embodiment, the processor 120 may be configured to synchronize the clipboard 1000 in a plurality of electronic devices 101 connected to a user device group based on a user account.

According to an example embodiment, the processor 120 may be configured to analyze the context of the task based on recent content of a current execution screen, a currently focused execution screen among multiple execution screens based on multiple windows, and/or contextual information of the user.

According to an example embodiment, the processor 120 may be configured to classify the extracted clip data based on contextual information each corresponding clip data, and to provide the clipboard 1000 with a corresponding a sorting interface based on a result of the classification.

According to an example embodiment, the processor 120 may be configured to detect a user input for pinning at least one piece of clip data to a designated area on the clipboard 1000, and to pin and provide the at least one piece of clip data to the designated area within the clipboard 1000 based on the user input.

According to an example embodiment, when calling the clipboard 1000, the processor 120 may be configured to identify a designated policy related to access to the clipboard 1000, to extract the clip data based on an account logged into the electronic device 101 to provide the clipboard 1000 when the designated policy is a first designated policy, and to extract clip data configured in a public manner to provide the clipboard 1000 when the designated policy is a second designated policy.

According to an example embodiment, the processor 120 may be configured to collectively or individually provide settings of a public-based first policy, a login account-based second policy, or a third policy that is limited to a user account generating clip data, with respect to a plurality of pieces of clip data of the clipboard 1000.

According to an example embodiment, when the electronic device 101 detects logout of a user account, the processor 120 may be configured to collectively hide clip data generated based on the user account in the clipboard 1000, within the clipboard 1000.

According to an example embodiment, the processor 120 may be configured to synchronize changes in the clipboard 1000 with another electronic device connected based on a user account in real-time.

According to an example embodiment, the processor 120 may be configured to designate a sharing target of clip data in the clipboard 1000.

According to an example embodiment, the processor 120 may be configured to detect a user input related to selection of at least one piece of clip data in the clipboard 1000, to analyze contextual information of selected clip data based on the detection of the user input, to identify and execute an application associated with the clip data based on the contextual information, and to resume a user's task based on the clip data in the application.

According to an example embodiment, the processor 120 may be configured to detect a user input related to movement of clip data, to identify a movement area in which a user input is moved based on the detection of the user input, to execute a first function of pasting the clip data when an area in which the clip data is moved is a first designated area, and to execute a second function of resuming a task based on the clip data when the area in which the clip data is moved is a second designated area.

According to an example embodiment, the processor 120 may be configured to analyze contextual information of selected clip data based on a user input of selecting clip data in the clipboard 1000, to identify an application capable of executing a task related to the clip data based on the contextual information, and to resume clip data-based user's task based on the identified application.

According to an example embodiment, the processor 120 may be configured to identify an application designated in the clip data, a currently executed application, and/or an alternative related application.

Hereinafter, an operating method of the electronic device 101 according to various embodiments will be described in detail. Operations performed by the electronic device 101 described below may be performed by a processor (e.g., the processor 120 of FIG. 1 or 2) including at least one processing circuitry of the electronic device 101. According to an embodiment, operations performed by the electronic device 101 may be performed by instructions that are stored in the memory 130 and cause the processor 120 to operate when executed.

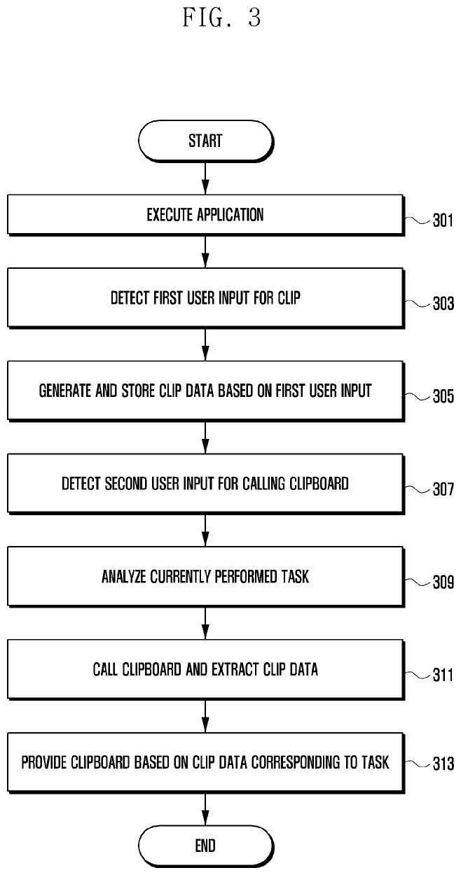

FIG. 3 is a flowcharting illustrating an operating method of an electronic device according to various embodiments.

Referring to FIG. 3, in operation 301, the processor 120 of the electronic device 101 may execute an application. According to an embodiment, the processor 120 may execute an application requested to be executed by a user and may display an execution screen of the executed application through the display module 160.

In operation 303, the processor 120 may detect a first user input for a clip of designated content while displaying the execution screen of the application. According to an embodiment, the user may designate (e.g., select) content for clip data on the execution screen of the application being displayed on the display module 160, and may input a designated user interaction (e.g., a first user input) for clipping designated content (e.g., storing the corresponding content as clip data through cut or copy). According to an embodiment, the clipping of the designated content will be described with reference to drawings to be described later.

In operation 305, the processor 120 may generate clip data related to the content based on the first user input and may store the generated clip data in the memory 130 (e.g., the database 220). According to an embodiment, the clip data may include a clip object (e.g., a copy object) related to designated content and contextual information related to the clip object (or content).

According to an embodiment, when generating the clip data, the processor 120 may analyze (or identify or extract) contextual information such as a type of a clip object (or content), identification information (e.g., type, link {e.g., URL}, and/or name) of an application, a task being performed by an application, and/or a variety of contextual information (or TPO information) related to a user (or the electronic device 101) at the time of clipping operation, together with the clip object.

According to an embodiment, the processor 120 may map the contextual information and the clip object according to the analysis result, and may store the clip data in the memory 130. According to an embodiment, the processor 120 may store the clip object in the clipboard 210, and may store and manage the contextual information liked with the clip object of the clipboard 210 in the database 220 in the form of a lookup table. According to an embodiment, an operation of generating clip data will be described with reference to drawings to be described later.

In operation 307, the processor 120 may detect a second user input for calling the clipboard. According to an embodiment, the user may execute the application of operation 301 or an application different from the application of operation 301, and may input a designated user interaction (e.g., a second user input) for calling (or displaying) the clipboard for use (e.g., paste) of clip data.

In operation 309, the processor 120 may analyze the currently performed task based on the detection of the second user input. According to an embodiment, the processor 120 may analyze (or recognize) an application currently being executed in the electronic device 101 and/or a context (or a state) of the task being performed in the executed application based on the detection of the second user input. For example, the processor 120 may analyze a task-related context such as identification information (e.g., type, link {e.g., URL}, and/or name) of an application, a task being performed by an application, and/or a variety of contextual information (or TPO information) related to a user (or the electronic device 101) at the time of calling a clipboard. According to an embodiment, the processor 120 may understand the context of a current task through machine learning.

In operation 311, the processor 120 may call the clipboard (e.g., 210/1000) and extract the clip data based on the detection of the second user input. According to an embodiment, the processor 120 may extract clip data corresponding to the analyzed task (or context of the task) among a plurality of pieces of clip data of the clipboard in an operation of calling the clipboard. According to an embodiment, an operation of extracting the clip data corresponding to the task will be described with reference to drawings to be described later.

In operation 313, the processor 120 may provide (e.g., display) the clipboard based on the clip data corresponding to the task. According to an embodiment, the processor 120 may provide a clipboard including (or recommending) only the clip data extracted in correspondence with the context of the task. According to an embodiment, the processor 120 may provide (e.g., display) the clipboard on the execution screen of the application through a designated area of the display module 160. For example, when providing the clipboard, the processor 120 may provide the clipboard by overlaying the clipboard on the execution screen, may provide the clipboard in a pop-up form by a pop-up window, or may provide the clipboard in a split area by a split window.

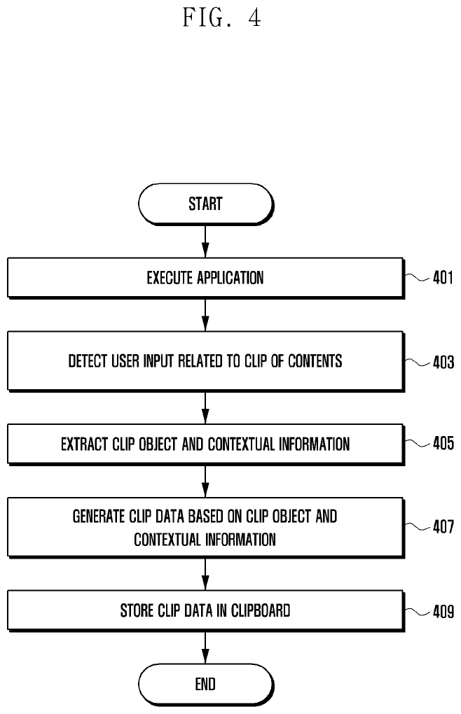

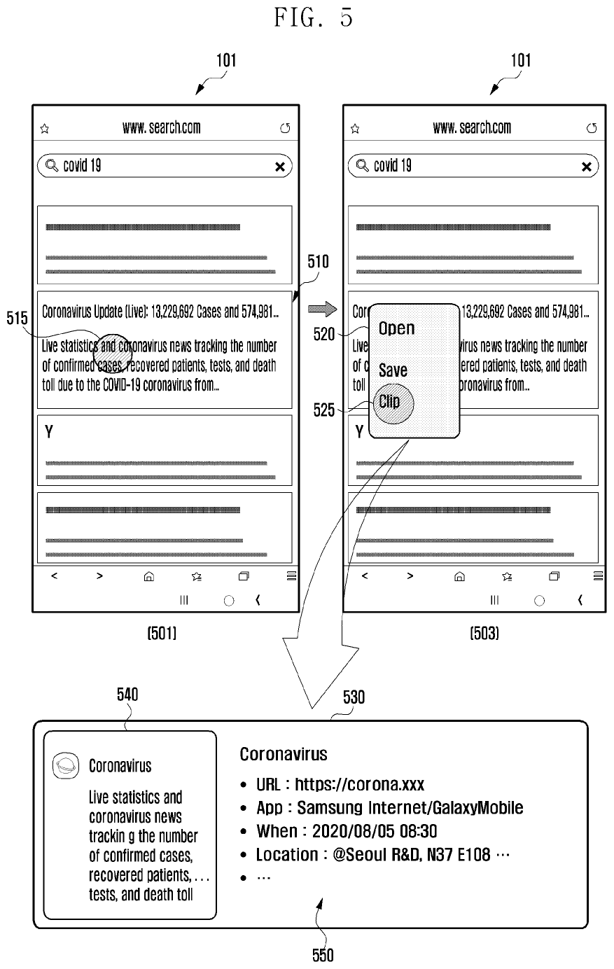

FIG. 4 is a flowchart illustrating an operating method of an electronic device according to various embodiments. FIG. 5 is a diagram illustrating an example of a clip of content and clip data generated according to the clip in an electronic device according to various embodiments.

According to an embodiment, FIGS. 4 and 5 may illustrate an operation example of generating clip data in the electronic device 101 according to various embodiments.

Referring to FIG. 4, in operation 401, the processor 120 of the electronic device 101 may execute an application. According to an embodiment, the processor 120 may execute an application requested to be executed by a user, and may display an execution screen of the executed application through the display module 160.

In operation 403, the processor 120 may detect a user input related to a clip of designated content while displaying the execution screen of the application. According to an embodiment, the user may designate (e.g., select) content for clip data on the execution screen of the application being displayed on the display module 160, and may input a designated user interaction (e.g., a user input) for clipping designated content (e.g., storing the designated content as the clip data through cut or copy). An example of this is shown in FIG. 5.

Referring to FIG. 5, as illustrated in example screen 501, the user may input a designated interaction 515 (e.g., a touch input {long press}) for clipping content 510 on the displayed execution screen. As illustrated in example screen 503, the electronic device 101 may provide an option menu 520 related to the operation (or execution) of designated content based on the user interaction 515, and the user may select (e.g., touch) an item 525 (e.g., clip) for clipping (e.g., storing the corresponding content as clip data through cut or copy) the designated content among various items (e.g., open, save, clip) of the option menu 520.

In operation 405, the processor 120 may extract a clip object and contextual information related to the designated content based on the user input. According to an embodiment, as illustrated in FIG. 5, the processor 120 may extract a clip object 540 (e.g., a copy object) based on the designated content 510, and may extract contextual information 550 related to the clip object 540 (or the content 510).

According to an embodiment, the processor 120 may extract the contextual information 550 such as a type of the clip object 540 (or content), identification information (e.g., type, link {e.g., URL}, and/or name) of an application, a task being performed by an application, and/or a variety of contextual information (or TPO information) related to a user (or the electronic device 101) at the time of the clipping operation. According to an embodiment, as the contextual information 550, at least one piece of information related to the designated content 510 may be extracted based on the example of Table 1 below. Table 1 below may indicate an example of configuring the contextual information 550 according to various embodiments.

TABLE 1

| | Main contents | |
|---|---|---|
| | (When user paste, main | |
| Data Type | contents will be pasted) | Contextual data |
| COMMON | — | - Clipped location |
| | | > App |
| | | > URL link (if any) |
| | | > Location within App, location value where |
| | | corresponding item is directly visible on screen |
| | | - At the time of being clipped |
| | | - Person (account) who clips |
| | | - How to clip (copy, share, smart select, capture . . .) |
| | | - Clipped geo location: coordinates and location |
| | | information |
| | | - Alternative applications (If there is no |
| | | corresponding app, list of apps that can be executed |
| | | instead) |
| | | - User context at the time of being clipped |
| | | > (In case of being continuously captured) Mirror |
| | | context information of image captured in bulk |
| | | > During call or not |
| | | > App used just before/App used immediately after |
| | | > Mute or not |
| | | > Landscape/Portrait |
| | | > . . . |
| Text | Text | - Before and after sentences (within certain range) |
| Screen | Image | - Image resolution |
| capture | | - Information on app executed at the time of clipping |
| (incl. Smart | | > Browser: URL |
| select) | | > Video: Current point during video playing time |
| | | > Video call: Call number, contact information |
| | | . . . |
| Image | Image | - Meta data of image |
| | | > Resolution |
| | | > Geo location |
| | | > Tag |
| | | > Photographing device |
| | | > Last modified, created time & date |
| Video | Video | - Meta data of video |
| | | > Resolution |
| | | > Geo location |
| | | > Tag |
| | | > Photographing device |
| | | > Last modified, created time & date |
| | | > playing time |
| MS Office | Object (Layered) | - URL information of cloud where contents are stored |
| objects | Text | - (In case of multiple objects) Layering information |
| | Style | between images, placement information, group status, |
| | | etc. |
| URL | URL | - Scroll information at the time of being captured |
| | Captured thumbnail | - Semantic information of corresponding URL webpage |
| Files | Files | - Files link (If there is any)- File execution information |
| Email | Email file | - Email detailed information |
| | | > Email type: sent, receive, draft, spam . . . |
| | | > Sender/Recipient information |
| | | > Date send/receive |
| | | > Presence or absence of attachments |
| Tasks | Tasks | - Schedule time range |
| | | - Category of task: work, private, family . . . |

As illustrated in Table 1, Table 1 may indicate examples of type and context determination criteria for clip data 530 of the clipboard. As illustrated in Table 1, the contextual information 550 may distinguish the type (e.g., data type) of the clip object 540 (e.g., a copy object), may commonly include contextual data corresponding to a common item, and may additionally include contextual data corresponding to the corresponding type (e.g., text, screen, capture, image, video, . . . ) of the clip object 540. According to an embodiment, as illustrated in Table 1, when contents are clipped, the contextual information 550 may further include information on main contents (e.g., content of the clip object 540) to be used for pasting among the clipped contents.

In operation 407, the processor 120 may generate clip data based on the clip object and the contextual information. According to an embodiment, as illustrated in FIG. 5, the clip data 530 may include the clip object 540 (e.g., a copy object) related to the designated contents 510 and the contextual information 550 related to the clip object 540 (or contents). According to an embodiment, when generating the clip data 530, the processor 120 may generate the contextual information 550 such as the type of the clip object 540 (or contents), identification information (e.g., type, link {URL}, and/or name), a task being performed by an application, and a variety of contextual information (or TPO information) related to a user (or the electronic device 101) at the time of clipping operation, together with the clip object 540 clipped from the contents. For example, the processor 120 may extract and configure the contextual information 550 based on various pieces of contextual information corresponding to the type of the clip object 540 as shown in Table 1.

In operation 409, the processor 120 may store the clip data in the clipboard. According to an embodiment, the processor 120 may map the clip object 540 and the contextual information 550 and may store the mapped information as the clip data 530 in the memory 130. According to an embodiment, the processor 120 may store and manage the clip data 530 including the clip object 540 and the contextual information 550 linked to the clip object 540 in the form of a lookup table.

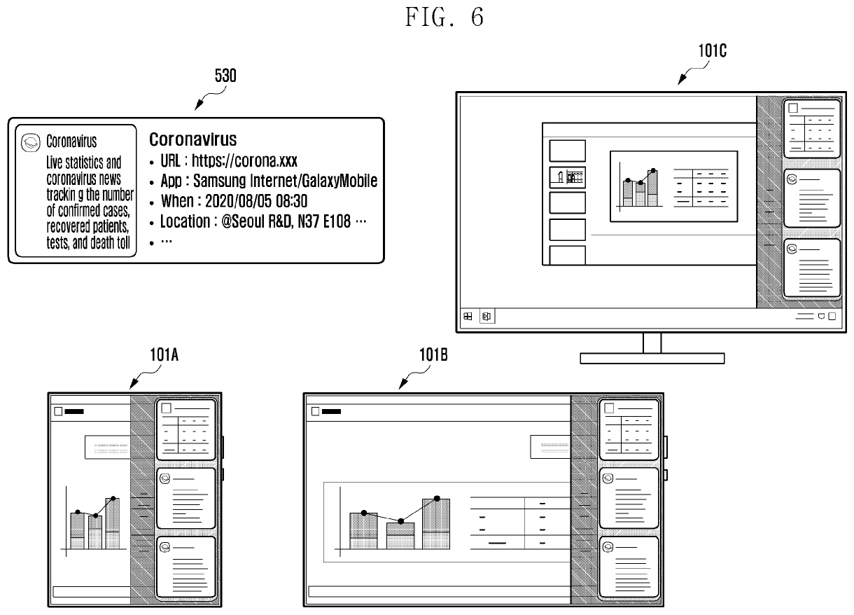

FIG. 6 is a diagram illustrating an example of providing a clipboard according to various embodiment.

According to an embodiment, FIG. 6 may illustrate an example in which the clip data 530 stored in the clipboard is shared with (account-based shared or synchronized with) other electronic devices and is used when the electronic device 101 generates the clip data 530 and stores the generated clip data 530 in the clipboard of the electronic device 101.

As illustrated in FIG. 6, the user may own various electronic devices 101 (e.g., a first electronic device 101A, a second electronic device 101B, and a third electronic device 101C). The various electronic devices 101 of the user (e.g., the first electronic device 101A, the second electronic device 101B, and the third electronic device 101C) may be managed to be connected to (linked with) a user device group based on a user account.

According to an embodiment, the clip data 530 generated in the electronic device 101 (e.g., the first electronic device 101A, the second electronic device 101B, or the third electronic device 101C) may be shared with (e.g., synchronized with) other electronic devices through the clipboard. According to an embodiment, the clipboard of the electronic device 101 may be linked with a cloud (e.g., the clipboard of the cloud) based on the user account. According to an embodiment, when the state of the clipboard in the electronic device 101 (e.g., the first electronic device 101A, the second electronic device 101B, or the third electronic device 101C) is changed (e.g., the clip data is added, changed, and/or deleted), the same state change may be applied to the clipboard of the cloud. For example, the clipboard of the electronic device 101 and the clipboard of the cloud may be synchronized with each other.

According to some embodiments, when the clipboard of the cloud is synchronized according to the state change of the clipboard of a certain electronic device 101 (e.g., the first electronic device 101A), the same state change may be applied to the clipboards of the other electronic devices 101 (e.g., the second electronic device 101B and the third electronic device 101C). For example, the clipboard of the cloud may be synchronized with the clipboards of various electronic devices 101 based on the user account.

According to some embodiments, the clipboard of the electronic device 101 may include a cloud-based clipboard. For example, the clip data generated by the electronic device 101 may be stored in the clipboard of the cloud, and a clipboard called by the electronic device 101 may be the clipboard of the cloud.

According to an embodiment, based on the clipboard operation as described above, the user may access the clipboard in the various electronic devices 101 of the user account such as the first electronic device 101A, the second electronic device 101B and the third electronic device 101C, and may use the common clip data 530 through the clipboard even in any electronic device 101.

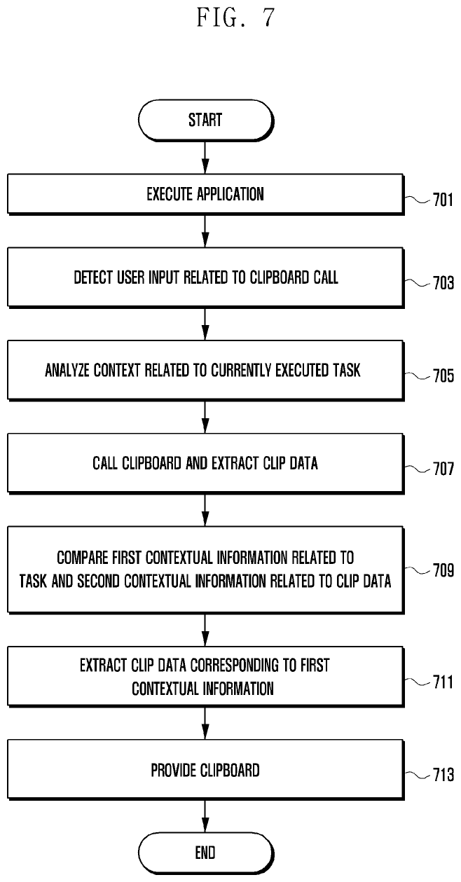

FIG. 7 is a flowchart illustrating an operating method of an electronic device according to various embodiments.

According to an embodiment, FIG. 7 illustrates an operation example of providing clip data in the electronic device 101 according to various embodiments.

Referring to FIG. 7, in operation 701, the processor 120 of the electronic device 101 may execute an application. According to an embodiment, the processor 120 may execute an application requested to be executed by a user and may display an execution screen of the executed application through the display module 160.

In operation 703, the processor 120 may detect a user input related to a clipboard call while displaying an execution screen of an application. According to an embodiment, the user may execute an application and may input a designated user interaction (e.g., a user input) for calling a clipboard (or displaying a clipboard) to use (e.g., paste) clip data. According to an embodiment, the user may perform the user input related to the clipboard call in a state in which the application is not executed (e.g., in a state in which a home screen is displayed).

In operation 705, the processor 120 may analyze a context related to a task currently being performed based on the detection of the user input. According to an embodiment, based on the detection of the user input, the processor 120 may analyze (or recognize) an application currently being executed in the electronic device 101 and/or a context (or state) of a task being performed in the executed application. For example, the processor 120 may analyze a task-related context such as identification information (e.g., type, link {URL}, and/or name) of an application, a task being performed by an application, and/or a variety of contextual information (or TPO information) related to the user (e.g., the electronic device 101) at the time of calling a clipboard. According to an embodiment, the processor 120 may identify first contextual information based on the analyze of the task-related context. According to an embodiment, the processor 120 may understand the context of the current task through machine learning.

In operation 707, the processor 120 may call the clipboard and extract clip data based on the detection of the user input. According to an embodiment, the processor 120 may extract a plurality of pieces of clip data stored in the clip board when calling the clipboard. According to an embodiment, the processor 120 may identify (or extract) contextual information (e.g., second contextual information) corresponding to each clip data when extracting the clip data.

In operation 709, the processor 120 may compare the first contextual information according to the analysis of the task-related context with the second contextual information related to the clip data. According to an embodiment, the processor 120 may identify contextual information (e.g., third contextual information) corresponding to (coinciding with) the first contextual information from the second contextual information related to the clip data.

In operation 711, the processor 120 may extract the clip data corresponding to the first contextual information among the plurality of pieces of clip data of the clipboard. According to an embodiment, the processor 120 may identify at least one piece of clip data related to the third contextual information among the plurality of pieces of clip data of the clipboard. For example, the processor 120 may extract clip data related to a task currently being performed from the plurality of pieces of clip data of the clipboard.

In operation 713, the processor 120 may provide (e.g., display) the clipboard based on the extracted clip data. According to an embodiment, the processor 120 may provide (e.g., display) the clipboard based on the clip data related to the task currently being performed. According to an embodiment, the processor 120 may provide the clipboard including (or recommending) only the clip data extracted in correspondence with the context of the task. According to an embodiment, the processor 120 may provide (e.g., display) the clipboard on an execution screen of the application through a designated area of the display module 160. For example, when providing the clipboard, the processor 120 may provide the clipboard by overlaying the clipboard on the execution screen, may provide the clipboard in a pop-up form by a pop-up window, or may provide the clipboard in a split area by a split window.

According to some embodiments, when providing the clipboard, the processor 120 may include and provide various user interfaces related to a clipboard operation, and may sort and provide clip data in the clipboard according to a designated method. According to an embodiment, an operation of operating the clipboard will be described with reference to drawings to be described later.

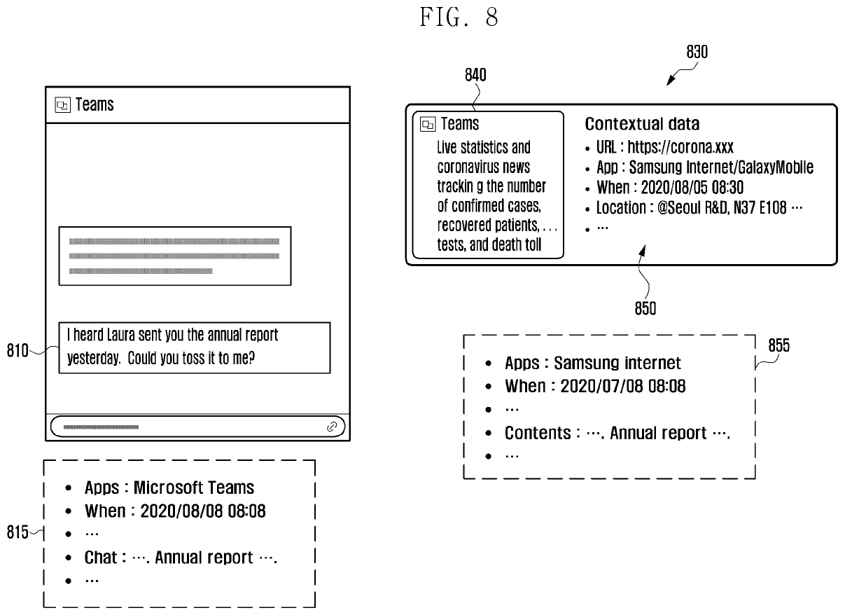

FIG. 8 is a diagram illustrating an example of providing clip data of a clipboard in an electronic device according to various embodiments.

According to an embodiment, FIG. 8 illustrates an operation example of providing (or recommending) corresponding clip data by analyzing a task based on recent contents of a current execution screen in the electronic device 101 according to various embodiments.

Referring to FIG. 8, the electronic device 101 may currently display a plurality of contents based on execution of an application (e.g., a messenger application). According to an embodiment, FIG. 8 illustrates an example in which contents 810 among the plurality of contents are recent contents and a task is analyzed based on the recent contents 810.

According to an embodiment, when calling a clipboard based on a user input, the electronic device 101 may analyze (or recognize) a currently executed application and a context (e.g., a context based on the contents 810) of a task being performed in the executed application. For example, the processor 120 may analyze a task-related context such as identification information (e.g., type, link {URL}, and/or name), a task being performed by an application, and/or a variety of contextual information (or TPO information) related to a user (or the electronic device 101) at the time of calling the clipboard. According to an embodiment, the electronic device 101 may configure first contextual information 815 of a current task (e.g., the contents 810) based on the analysis of the task-related context.

According to an embodiment, when calling the clipboard, the electronic device/processor 101/120 may identify (or extract) a clip object 840 corresponding to each clip data 830 and contextual information 850 (e.g., the second contextual information), from a plurality of pieces of clip data 830 stored in the clipboard.

According to an embodiment, the electronic device 101 may identify contextual information 855 (e.g., the third contextual information) corresponding to (coinciding with) the first contextual information, from the second contextual information 850 related to the clip data, based on a comparison between the first contextual information 815 related to the task and the second contextual information 850 related to the clip data. For example, in the example of FIG. 8, the electronic device 101 may extract at least one piece of third contextual information 855 including a context “Annual report” of the first contextual information 815, from the second contextual information 850 corresponding to each of the plurality of pieces of clip data 830.

According to an embodiment, the electronic device 101 may configure at least one piece of clip data corresponding to the extracted at least one piece of third contextual information 855, and may provide the configured clip data through the clipboard.

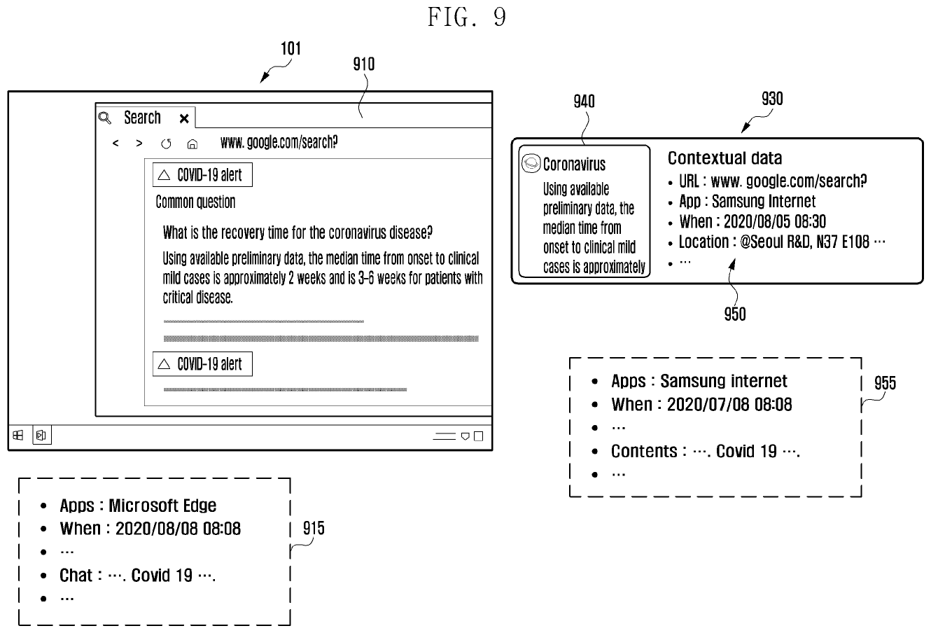

FIG. 9 is a diagram illustrating another example of providing clip data of a clipboard in an electronic device according to various embodiments.

According to an embodiment, FIG. 9 may illustrate an operation example of analyzing a task based on a currently focused execution screen among multiple execution screens based on multiple windows in the electronic device 101 according to various embodiments to provide (or recommend) corresponding clip data.

Referring to FIG. 9, the electronic device 101 may currently display a plurality of execution screens based on the multiple windows. According to an embodiment, FIG. 9 may illustrate an example of analyzing a task based on contents of a focused window 910 (or an execution screen) when the window 910 (or the execution screen) among the multiple windows is a currently focused window (or the execution screen).

According to an embodiment, the electronic device 101 may analyze, when calling the clipboard based on the user input, a task based on the contents of the currently focused window 910 to correspond to the above description, thereby configuring first contextual information 915 of the current task.

According to an embodiment, when calling the clipboard, the electronic device/processor 101/120 may identify (or extract) a clip object 940 and contextual information 950 (e.g., second contextual information) corresponding to each piece of the clip data 930, from a plurality of pieces of clip data 930 stored in the clipboard.

According to an embodiment, the electronic device 101 may identify contextual information 955 (e.g., third contextual information) corresponding to (or coinciding with) the first contextual information, from the second contextual information 950 related to the clip data, based on a comparison between the first contextual information 915 related to the task and the second contextual information 950 related to the clip data. For example, in the example of FIG. 9, the electronic device 101 may extract at least one piece of third contextual information 955 including a context “Covid 19” of the first contextual information 915 from the second contextual information 950 corresponding to each of the plurality of pieces of clip data 930.

According to an embodiment, the electronic device 101 may configure at least one piece of clip data corresponding to the extracted at least one piece of third contextual information 955, and may provide the configured clip data through the clipboard.

FIGS. 10A, 10B, and 10C are drawings illustrating other examples of providing clip data of a clipboard in an electronic device according to various embodiments.

According to an embodiment, FIGS. 10A, 10B, and 10C illustrate an operation example of analyzing a current application use context of a user in the electronic device 101 according to various embodiments to provide (or recommend) corresponding optimized clip data.

Referring to FIG. 10A, a user may currently perform a task related to image edition (e.g., insertion) in an execution screen 1010 of a first application by using the electronic device 101. According to an embodiment, the electronic device 101 may analyze a current task to analyze a use context of the user. For example, the electronic device 101 may determine that the user intends to insert an image into the execution screen 1010 of the first application as the current task.

According to an embodiment, the electronic device 101 may extract at least one piece of clip data (e.g., clip data 1011, 1013, and 1015 in which the type of the clip object is an image) of the contextual information related to the use context (e.g., image insertion) of the user from the plurality of pieces of clip data stored in the clipboard 1000. According to an embodiment, the electronic device 101 may provide (e.g., display a recommendation) the extracted at least one piece of clip data 1011, 1013, and 1015 to the clipboard 1000.

Referring to FIG. 10B, a user may currently perform a task related to the use of a webpage on an execution screen 1020 of a second application by using the electronic device 101. According to an embodiment, the electronic device 101 may analyze a use context of the user by analyzing the current task. For example, the electronic device 101 may determine that the user intends to use clip data related to contents of the web page on the execution screen 1020 of the second application, as the current task.

According to an embodiment, the electronic device 101 may extract at least one piece of clip data (e.g., clip data 1021, 1023, and 1025 in which the type of the clip object is URL) of the contextual information related to the use context of the user (the use of clip data relate to the contents of the webpage) from the plurality of pieces of clip data stored in the clipboard 1000. According to an embodiment, the electronic device 101 may provide (e.g., display a recommendation) the extracted at least one piece of clip data 1021, 1023, and 1025 to the clipboard 1000.

Referring to FIG. 10C, the user may currently perform a task related to writing an email on an execution screen 1030 of a third application by using the electronic device 101. According to an embodiment, the electronic device 101 may analyze a use context of the user by analyzing the current task. For example, the electronic device 101 may determine that the user intends to write an email on the execution screen 1030 of the third application, as the current task.

According to an embodiment, the electronic device 101 may extract at least one piece of clip data (e.g., clip data 1031 in which the type of the clip object is an email and a corresponding context is included) of the contextual information related to the use context (e.g., writing an email) of the user from the plurality of pieces of clip data stored in the clipboard 1000. According to an embodiment, the electronic device 101 may provide (e.g., display a recommendation) the extracted at least one piece of clip data 1031 to the clipboard 1000.

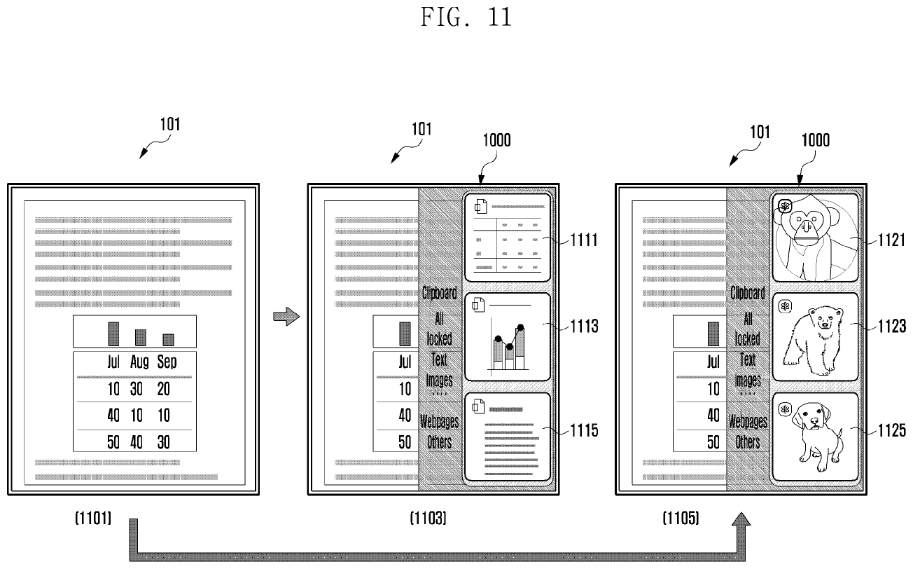

FIG. 11 is a diagram illustrating another example of providing clip data of a clipboard in an electronic device according to various embodiments.

According to an embodiment, FIG. 11 illustrates an operation example of providing (or recommending) corresponding optimized clip data by analyzing a use context of a current application of a user in an electronic device 101 according to various embodiments.

Referring to FIG. 11, the user may currently perform a task related to a document work on an execution screen of an application by using the electronic device 101 as illustrated in example screen 1101.

According to an embodiment, the electronic device 101 may analyze a current task to analyze a use context of a user (e.g., a previous action tracking of the user). For example, the electronic device 101 may determine that the user intends to perform document work on the execution screen of the application as the current task. According to an embodiment, the electronic device 101 may track (e.g., analyze a context) the user's previous action based on the current task, and may recommend and provide clip data corresponding to the clipboard 1000 based on the tracking result.

According to an embodiment, the user may repeatedly perform a copy & paste operation on an object (e.g., text and/or graph contents) included in the execution screen while performing document work, and may then call the clipboard 1000, as illustrated in example screen 1101. According to an embodiment, when calling the clipboard 1000 based on a user input, the electronic device 101 may extract, based on analysis of the use context of the user, object-based clip data 1111, 1113, and 1115 clipped while the current task (e.g., document work) is being performed, and may provide the extracted clip data to the clipboard 1000. For example, as illustrated in example screen 1103, the electronic device 101 may recommend (or prioritize) the clip data 1111, 1113, and 1115 related to the object among the clip data clipped on the clipboard 1000 while performing document work, and may provide the recommend clip data.

According to an embodiment, as illustrated in example screen 1101, the user may repeatedly perform a copy & paste operation on an image (e.g., image contents) included in the execution screen during document work, and may then call the clipboard 1000.

According to an embodiment, when calling the clipboard 1000 based on the user input, the electronic device 101 may extract clip data 1121, 1123, and 1125 based on an image clipped while performing the current task (e.g., document work), based on analysis of the use context of the user, and may provide the extracted clip data to the clipboard 1000. For example, as illustrated in example screen 1105, the electronic device 101 may recommend (or prioritize) the clip data 1121, 1123, and 1125 related to the image among the clip data clipped on the clipboard 1000 while performing document work, and may provide the recommend clip data.

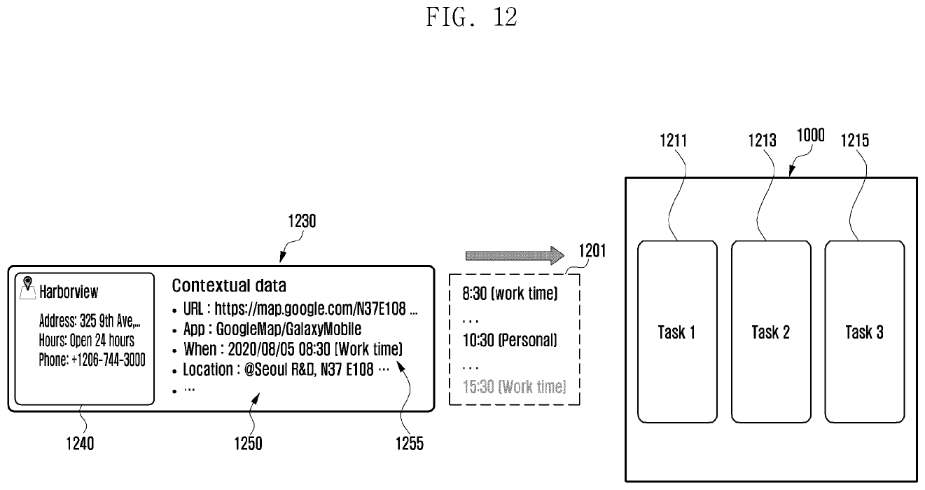

FIG. 12 is a diagram illustrating another example of providing clip data of a clipboard in an electronic device according to various embodiments.

According to an embodiment, FIG. 12 illustrates an operation example of supporting a user to resume a previous task based on clip data 1230 in the electronic device 101 according to various embodiments.

Referring to FIG. 12, the electronic device 101 may analyze a time at which a clip object 1240 is clipped based on contextual information 1250 (e.g., a time at which clip data 1230 is generated), from the clip data 1230 including the clip object 1240 and the contextual information 1250. For example, the electronic device 101 may determine whether the time at which the clip object 1240 is clipped is included in a first time range (e.g., a work hour range) or a second time range (e.g., a personal life time range), based on a time-related context 1255 in the contextual information 1250. According to an embodiment, the first time range and/or the second time range may be configured based on user designation or time information 1201 understood through machine learning.

According to an embodiment, when calling the clipboard 1000 based on the user input, the electronic device 101 may recommend (or prioritize) clip data 1211, 1213, and 1215 related to the current task (e.g., the first time range or the second time range) based on the contextual information related to a variety of contextual information (e.g., TPO information) related to the user, and may provide the recommended clip data. For example, when the time at which the clipboard 1000 is called is in the first time range, the electronic device 101 may extract the clip data 1211, 1213, and 1215 clipped in the first time range (e.g., work hour) from the plurality of pieces of clip data of the clipboard 1000, and may provide the extracted clip data through the clipboard 1000.

According to an embodiment, when the user calls the clipboard 1000 during the second work hour (e.g., 15:30 —) after the first work hour (e.g., 8:30 —) according to the first time range, the electronic device 101 may recognize that the second work hour belongs to the first time range, and may recommend at least one piece of clip data 1211, 1213, and 1215 clipped during the first work hour. According to an embodiment, the user may resume a task that continues to the previous task of the first work hour based on selection of any one clip data among the clip data 1211, 1213, and 1215. For example, based on the selected clip data, the electronic device 101 may provide an execution screen in which a corresponding application is executed and the previous task has been performed in the corresponding application.

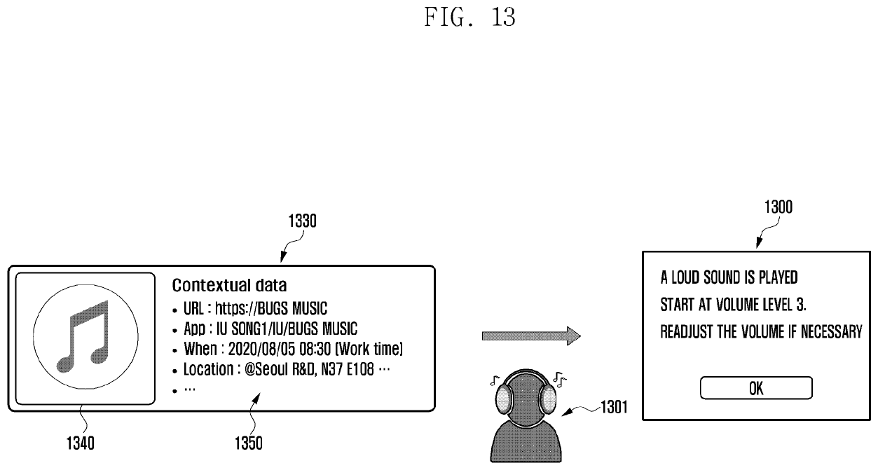

FIG. 13 is a diagram illustrating another example of providing clip data of a clipboard in an electronic device according to various embodiments.

According to an embodiment, FIG. 13 illustrates an operation example in which a user resumes a previous task based on clip data 1330 in the electronic device 101 according to various embodiments.

Referring to FIG. 13, the electronic device 101 may analyze the type of a clip object 1340 based on contextual information 1350 from the clip data 1330 including the clip object 1340 and the contextual information 1350. According to an embodiment, when the clip data 1330 is selected by the user in a currently displayed clipboard, the electronic device 101 may determine whether the clip data 1330 corresponds to the clip data 1330 related to generation of sound according to media (e.g., music and/or video) playback based on the clip object 1340 and/or the contextual information 1350.

According to an embodiment, when the electronic device 101 determines to resume the task based on the user's selection of the clip data 1330, the electronic device 101 may provide guidance and/or function control related to the task resumption by the clip data 1330 in consideration of a variety of contextual information 1301 (e.g., a headset or earphone wearing state) related to the user.

According to an embodiment, when the electronic device 101 determines that the user is attempting to resume a task related to sound generation, such as media playback, while the user is wearing an external audio device (e.g., a headset or earphone), the electronic device 101 may provide related guidance 1300 and function control. For example, in order to prevent or reduce hearing damage due to a sudden loud sound, the electronic device 101 may automatically adjust (e.g., adjust volume level 3) a corresponding function while providing (e.g., visually display and/or auditorily output) a related guidance 1300 (e.g., “A loud sound is played. Start at volume level 3. Readjust the volume if necessary”), and may then process resumption (e.g., media playback) of the task by the clip data 1330.

According to an embodiment when the user is attempting to resume a task related to sound generation, such as media playback, while the user is not wearing an external audio device (e.g., a headset and/or earphone), the electronic device 101 may provide related guidance and function control. For example, in order to prevent or reduce a chance of sudden occurrence of sound in a public place, the electronic device 101 may automatically control a corresponding function (e.g., adjust to a minimum volume level) while providing the related guidance as visual and/or audible information, and may then process resumption (e.g., media playback) of the task by the clip data 1330.

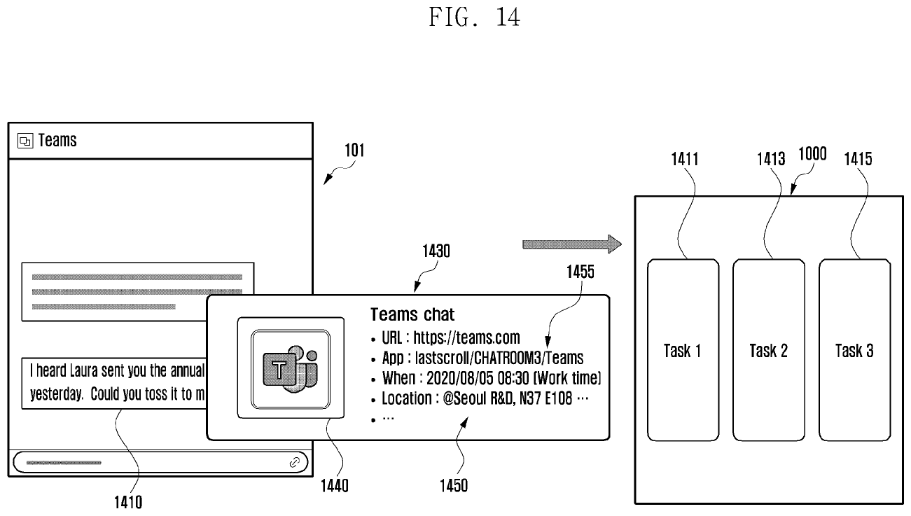

FIG. 14 is a diagram illustrating another example of providing clip data of a clipboard in an electronic device according to various embodiments.

According to an embodiment, FIG. 14 may illustrate an operation example of supporting a previous task of a user to be resumed based on clip data 1430 in the electronic device 101 according to various embodiments.

Referring to FIG. 14, the electronic device 101 may analyze an application (e.g., a messenger application) in which a clip object 1440 is clipped based on contextual information 1450 and/or depth in the application, in the clip data 1430 including the clip object 1440 and the contextual information 1450. For example, the electronic device 101 may analyze a current task to analyze an application use context (e.g., a previous action tracking of a user) of the user.

According to an embodiment, when calling a clipboard 1000 based on a user input, the electronic device 101 may recommend (or prioritize) and provide clip data 1411, 1413, and 1415 related to a current task (e.g., the application and depth), based on contextual information related to an application currently being performed. For example, the electronic device 101 may track (e.g., analyze a context) a type (e.g., a messenger application) of an application from which the clipboard 1000 is called and a user's previous action in the application, and may recommend and provide the clip data 1411, 1413, and 1415 corresponding to the clipboard 1000 based on the tracking result.

According to an embodiment, after a user performs an operation of clipping at least one content (e.g., contents 1410) in a designated chat room through a messenger application and terminates the messenger application, the electronic device 101 may enter the designated chat room through the messenger application again to call the clipboard 1000. According to an embodiment, the electronic device 101 may recognize the executed application (e.g., the messenger application) and the depth (e.g., the chat room) when calling the clipboard 1000.

According to an embodiment, the electronic device 101 may extract at least one clip data 1411, 1413, and 1415 clipped in the depth of the application based on a context 1455 related to the application in the contextual information 1450 of the clip data 1430, and may provide the extracted at least one clip data 1411, 1413, and 1415 to the clipboard 1000. For example, when re-performing the previous task, the electronic device 101 may recommend the clip data 1411, 1413, and 1415 clipped in the previous task to provide a reminder of the user's previous task.

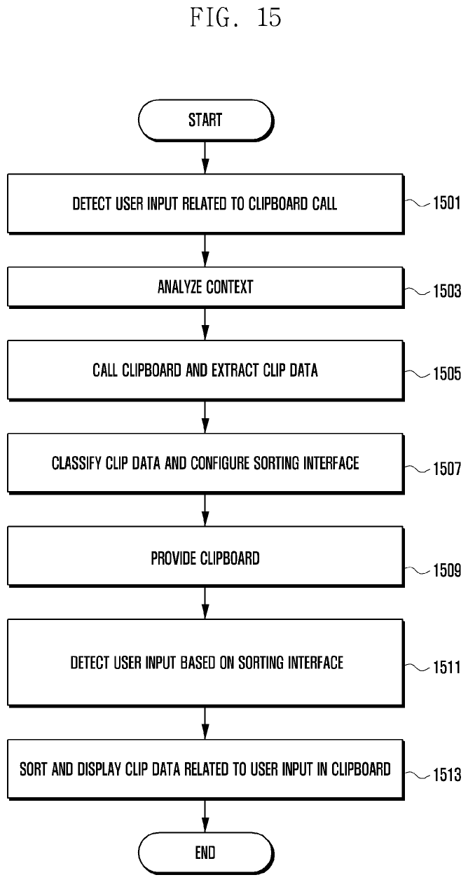

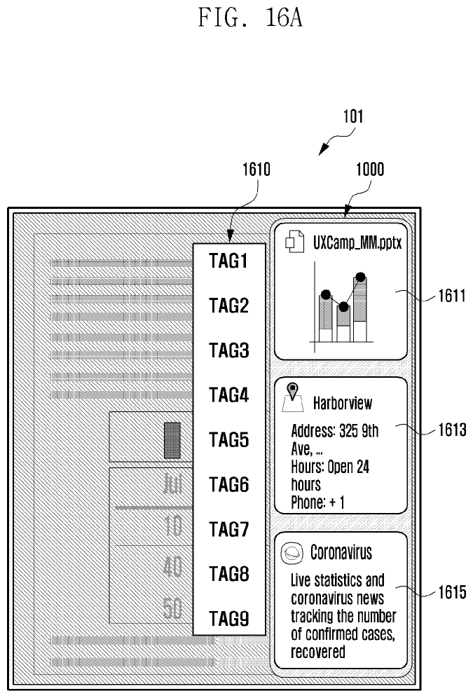

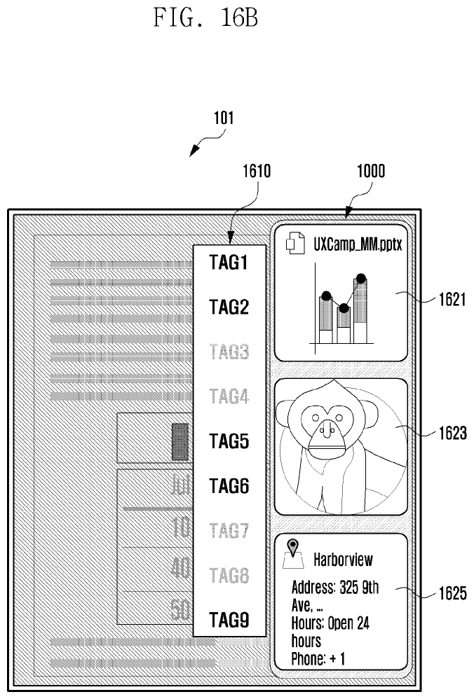

FIG. 15 is a diagram illustrating an operating method of an electronic device according to various embodiments. FIGS. 16A and 16B are diagrams illustrating an example of providing a clipboard in an electronic device according to various embodiments.

According to an embodiment, FIGS. 15, 16A, and 16B may illustrate an operation example of providing a clipboard (or an interface related to the clipboard) in the electronic device 101 according to various embodiments.

Referring to FIG. 15, in operation 1501, the processor 120 of the electronic device 101 may detect a user input related to a clipboard call. According to an embodiment, a user may execute an application and may input a designated user interaction (e.g., a user input) for calling a clipboard (or displaying a clipboard) to use (e.g., paste) clip data. According to some embodiments, the user may perform a user input related to the clipboard call in a state in which the corresponding application is not executed (e.g., a state in which a home screen is displayed).

In operation 1503, the processor 120 may analyze a context related to the currently being executed task based on the detection of the user input. According to an embodiment, the processor 120 may analyze (or recognize) an application currently being executed in the electronic device 101 and/or the context (or the state) of the task currently being performed in the executed application, based on the detection of the user input. For example, the processor 120 may analyze the task-related context such as identification information (e.g., a type, link {URL}, and/or name) of an application, a task being performed by an application, and/or a variety of contextual information (e.g., TPO information) related to a user (or the electronic device 101) at the time of a clipboard. According to an embodiment, the processor 120 may identify first contextual information based on analysis of the context related to the task.

In operation 1505, the processor 120 may call the clipboard and extract the clip data based on the detection of the user input. According to an embodiment, the processor 120 may extract at least one clip data of second contextual information corresponding to (coinciding with) the first contextual information, based on a comparison between the second contextual information and the first contextual information respectively corresponding to the plurality of pieces of clip data stored in the clipboard. For example, the processor 120 may extract the clip data related to the currently performed task among the plurality of pieces of clip data of the clipboard.

In operation 1507, the processor 120 may classify the extracted clip data and may configure a sorting interface (e.g., a sorting object or a tag object) corresponding to the classification. According to an embodiment, the processor 120 may classify (category classification) the extracted clip data based on a designated type (e.g., data type, application, clipped time, clipped location {or place} {e.g., geo location}, or user situation), based on the second contextual information of the extracted clip data, and may configure a corresponding sorting interface (e.g., a sorting object or a tag object) based on the classification result. For example, the processor 120 may configure a sorting interface that is mapped one-to-one for each category.

In operation 1509, the processor 120 may provide (e.g., display) the clipboard based on the extracted clip data and the sorting interface. According to an embodiment, the processor 120 may include the clip data related to the currently performed task and the sorting interface configured to correspond to classification of the clip data to provide (display) the clipboard. An example of this is illustrated in FIG. 16A.

Referring to FIG. 16A, as illustrated in FIG. 16A, the electronic device 101 may display a plurality of pieces of clip data 1611, 1613, and 1615 on the clipboard 1000, and may include a sorting interface 1610 (e.g., a sorting object or a tag object) for sorting the plurality of pieces of clip data 1611, 1613, and 1615 for each designated type to provide the clipboard 1000. According to an embodiment, the sorting interface 1610 may be configured with the number corresponding to classification number classified from the clip data 1611, 1613, and 1615, and may be provided.

In operation 1511, the processor 120 may detect a user input based on the sorting interface. According to an embodiment, the processor 120 may detect a user input for selecting (e.g., touching) at least one sorting object in the sorting interface 1610 while displaying the clipboard 1000 including the clip data 1611, 1613, and 1615 as illustrated in FIG. 16A. According to an embodiment, the user may select one or more sorting objects from the sorting interface 1610 and may designate a sorting object. According to an embodiment, referring to FIG. 16A, the user may select a plurality of sorting objects of a first sorting object (e.g., TAG3), a second sorting object (e.g., TAG4), a third sorting object (e.g., TAG7), and a fourth sorting object (e.g., TAG8) in the sorting interface 1610, and may designate the clip data of the corresponding classification as the sorting object.

In operation 1513, the processor 120 may sort and display the clip data related to the user input in the clipboard based on the detection of the user input. According to an embodiment, the processor 120 may sort the clip data of the designated classification through the sorting interface among the extracted clip data to provide the sorted clip data to the clipboard 1000. An example of this is illustrated in FIG. 16B.

Referring to FIG. 16B, as illustrated in FIG. 16B, an example in which the user selects the first sorting object (e.g., TAG3), the second sorting object (e.g., TAG4), the third sorting object (e.g., TAG7), and the fourth sorting object (e.g., TAG8) in the sorting interface 1610. According to an embodiment, the electronic device 101 may extract only clip data 1621, 1623, and 1625 respectively corresponding to the classification of the selected sorting objects among the clip data 1611, 1613, and 1615 in the clipboard 1000, and may re-sort the extracted clip data 1621, 1623, and 1625 to provide the re-sorted clip data to the clipboard 1000. According to an embodiment, the user may more easily search for the clip data in the clipboard 1000 based on a selection for activating/deactivating (or turning on/off) the sorting object of the sorting interface 1610.

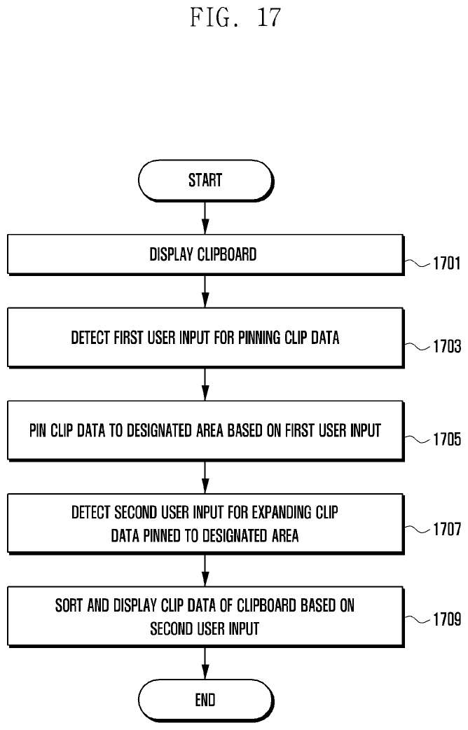

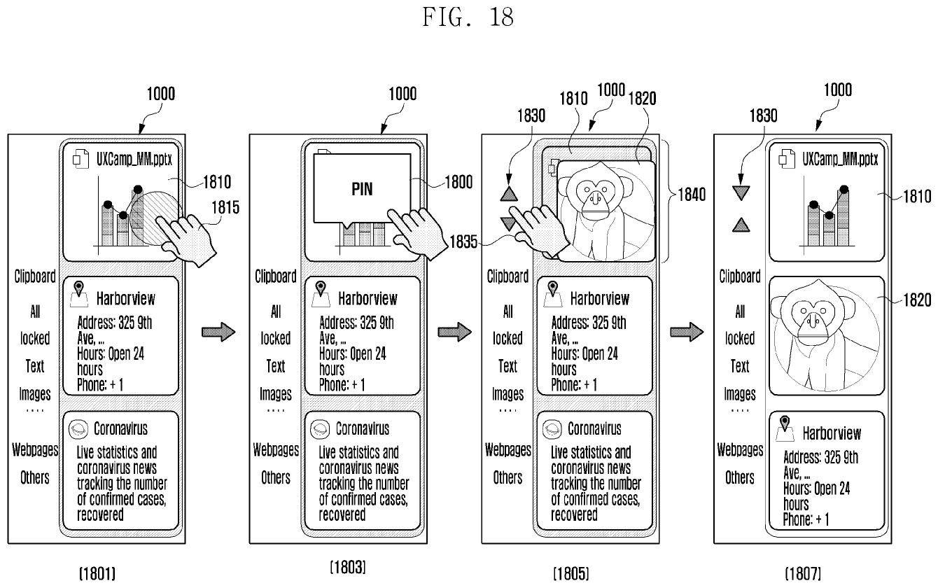

FIG. 17 is a flowchart illustrating an operating method of an electronic device according to various embodiments. FIG. 18 is a diagram illustrating an example of providing a clipboard in an electronic device according to various embodiments.

According to an embodiment, FIGS. 17 and 18 may illustrate an operation of providing (e.g., managing) clip data of a clipboard in the electronic device 101 according to various embodiments.

Referring to FIG. 17, in operation 1701, the processor 120 of the electronic device 101 may display a clipboard. According to an embodiment, the processor 120 may call and display the clipboard based on a designated user input related to a clipboard call. According to an embodiment, the clipboard may include a plurality of pieces of clip data clipped by a user.

In operation 1703, the processor 120 may detect a first user input for pinning at least one piece of clip data in the clipboard. According to an embodiment, the user may execute the clipboard and may input a designated user interaction (e.g., the first user input) for pinning the at least one piece of clip data among the clip data of the clipboard. An example of this is illustrated in example screens 1801 and 1803 of FIG. 18.

Referring to FIG. 18, as illustrated in example screen 1801, the user may input a first user input 1815 for designating clip data 1810 to be always pinned to a designated area (e.g., an upper area) of the clipboard 1000 based on the clip data 1810 among the plurality of pieces of clip data provided through the clipboard 1000. According to an embodiment, the first user input 1815 may be an input for instructing the clip data 1810 to be pinned on the clip data 1810, and may be configured in various input methods, for example, a long press input, a double tap input, a flick input, or a swipe input.

As illustrated in example screen 1803, in response to the first user input 1815, the electronic device 101 may provide an option menu 1800 capable of instructing the clip data 1810 to be pinned based on the designated clip data 1810. According to an embodiment, the option menu 1800 may further include other items related to management (or operation or editing) of the designated clip data 1810 in addition to an item (e.g., a PIN object) for pinning the clip data 1810.

According to some embodiments, the electronic device 101 may process the clip data 1810 to be directly pinned based on the first user input 1815 without providing the option menu 1800, according to the settings or operating method of the electronic device 101.

In operation 1705, the processor 120 may pin the clip data to the designated area within the clipboard based on the first user input, and may provide the pinned clip data. According to an embodiment, the processor 120 may configure the designated clip data to be always pinned to the upper area of the clipboard based on the first user input and to be provided (e.g., displayed). An example of this is illustrated in example screen 1805 of FIG. 18.

Referring to FIG. 18, as illustrated in example screen 1805, the electronic device 101 may pin and display the designated clip data 1810 to the designated area 1840 within the clipboard 1000 through the first user input 1815 and/or the option menu 1800. For example, the designated area 1840 may be an upper area of an area where the clip data is provided in the clipboard 1000.

According to an embodiment, in example screen 1805, based on the above-described operation, the first clip data 1810 may be pinned and designated by the user, and then the second clip data 1820 may be pinned and designated. For example, the user may pin the plurality of pieces of clip data 1810 and 1820 to the designated area 1840 based on the clip data of the clipboard. According to an embodiment, when the plurality of pieces of clip data 1810 and 1820 are pinned and designated, the electronic device 101 may expose the pinned and designated clip data (e.g., second clip data 1820) to a higher layer of the designated area 1840 based on the latest order and may provide the exposed clip data.

In operation 1707, the processor 120 may detect a second user input for expanding the clip data pinned to the designated area. According to an embodiment, the user may input a designated user interaction (e.g., the second user input) for expanding the clip data of the designated area in the clipboard. An example of this is illustrated in example screen 1805 of FIG. 18.

Referring to FIG. 18, as illustrated in example screen 1805, the user may input a second user input 1835 for expanding and confirming the clip data 1810 and 1820 overlapped on and pinned to the designed area 1840 in the clipboard 1000 based on the clip data (e.g., the second clip data 1820) of the designated area 1840 or a designated sorting object 1830. According to an embodiment, the second user input 1835 may be an input for instructing the clip data overlapped on the designated area 1840 to be expanded, and may be configured in various input methods, for example, a long press input, a double tap input, an up/down or left/right flick, or a swipe input.

According to some embodiments, when a plurality of pieces of clip data 1810 and 1820 are pinned to and designated in the designated area 1840, the electronic device 101 may allow the user to easily identify a state in which the plurality of pieces of clip data 1810 and 1820 are pinned to and overlapped on the designated area 1840, and may provide a sorting object 1830 capable of sorting (e.g., expanding or reducing) the clip data of the designated area 1840.

According to some embodiments, the electronic device 101 may overlap, in parallel or alternatively, the sorting object 1830 and the clip data 1810 and 1820 of the designated area 1840 in a shifted manner to provide an overlapped state in such a way that a part of the clip data of a lower layer is displayed. According to an embodiment, the user may sort (e.g., expand or reduce) the clip data 1810 and 1820 pinned to and designated in the designated area 1840, based on the second user input 1835 on the designated area 1840 or the second user input 1835 based on the sorting object 1830.

According to an embodiment, based on the sorting state (e.g., reduced (or overlapped) state or an expanded state) of the clip data 1810 and 1820 of the designated area 1840, the sorting object 1830 may be converted into an expanded item (e.g., see the sorting object 1830 of example screen 1805) or reduced item (e.g., see the sorting object 1830 of example screen 1807) form.

In operation 1709, the processor 120 may sort and provide the clip data of the clipboard in a designated manner based on the detection of the second user input. According to an embodiment, the processor 120 may expand the plurality of overlapped clip data of the designated area based on the second user input and may provide them without overlapping each other. An example of this is illustrated in example screen 1807 of FIG. 18.

Referring to FIG. 18, as illustrated in example screen 1807, the electronic device 101 may expand the overlapped clip data 1810 and 1820 of the designated area 1840 and may sort and display the clip data 1810 and 1820 so that they do not overlap each other, in response to the second user input 1835 based on the designated area 1840 or the sorting object 1830 (e.g., an expanded item).

For example, the designated area 1840 may be an upper area of an area wherein the clip data is provided in the clipboard 1000, and the electronic device 101 may expand the designated area 1840 in a downward direction with respect to the upper area to provide the clip data 1810 and 1820. According to an embodiment, other clip data within the clipboard 1000 may be moved and sorted based on the expansion of the designated area 1840 (or the expanding of the overlapped clip data 1810 and 1820).

According to an embodiment, the user may input a third user input (not shown) for reducing and sorting the expanded clip data 1810 and 1820 to the designated area 1840 on the clipboard 1000 based on the designated area 1840. According to an embodiment, the third user input is an input for instructing the expanded clip data on the designated area 1840 to be combined (or overlapped), and may be configured in various input methods such as a long press input, a double tap input, an up/down or left/right flick, or a swipe input.

According to some embodiments, the electronic device 101 may allow the user to easily identify a state in which the clip data 1810 and 1820 are expanded in the designated area 1840, and may provide the sorting object 1830 capable of sorting (e.g., reducing) the expanded clip data of the designated area 1840. For example, as illustrated in example screen 1807, the sorting object 1830 may be converted into a reduced item form and provided.

According to an embodiment, the user may sort and display the clip data 1810 and 1820 expanded in the designated area 1840 so as to be overlapped each other, based on the third user input based on the designated area 1840 or the sorting object 1830. For example, the electronic device 101 may provide a state such as example screen 1805.

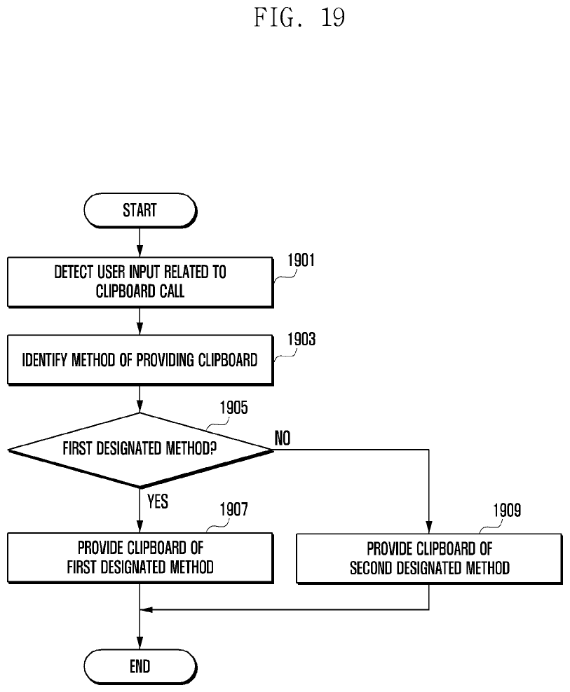

FIG. 19 is a flowchart illustrating an operating method of an electronic device according to various embodiments.

According to an embodiment, FIG. 19 may illustrate an operation example of providing (e.g., managing) clip data of a clipboard in the electronic device 101 according to various embodiments. For example, FIG. 19 may illustrate an example of providing a clipboard based on a designated policy for the clipboard in the electronic device 101.

Referring to FIG. 19, in operation 1901, the processor 120 of the electronic device 101 may detect a user input related to a clipboard call. According to an embodiment, a user may input a designated user interaction (e.g., a user input) for calling a clipboard (or displaying a clipboard) to use clip data.

In operation 1903, the processor 120 may identify a designated method of providing a clipboard (e.g., a designated policy for the clipboard) based on the detection of the user input. According to an embodiment, the designated method of providing a clipboard may include, for example, a method of providing a clipboard based on an account according to user settings (e.g., a first designated method) and/or a method of providing a clipboard on a public basis regardless of an account (e.g., a second designated method).

According to some embodiments, the first designated method may include a private method that allows access to a corresponding clipboard at the time of login by a user account based on the user account, and a permission method that allows partial access to a corresponding clipboard at the time of login with an account pre-registered (or permitted) by a user base on a permission account of the user.

In operation 1905, the processor 120 may determine whether the first designated method or the second designated method is configured based on the identification result.

When the first designated method is configured in relation to the access to the clipboard in operation 1905 (e.g., “YES” in operation 1905), in operation 1907, the processor 120 may provide the clipboard based on the first designated method. According to an embodiment, the processor 120 may identify a user account logged in the electronic device 101, and may extract clip data related to the logged-in user account to provide the clipboard.

According to some embodiments, when the account logged in the electronic device 101 is a permission account pre-registered (or permitted) by the user account, the processor 120 may extract clip data related to the logged-in permission account to provide the clipboard. According to some embodiments, when there is no user account logged into the electronic device 101 (e.g. a logout state), the processor 120 may not execute the clipboard, or may provide a clipboard (e.g., an empty clipboard) from which all the clip data is excluded.

In operation 1905, when the second designated method is configured in relation to the access to the clipboard in operation 1905 (e.g., “NO” in operation 1905), in operation 1909, the processor 120 may provide the clipboard based on the second designated method. According to an embodiment, the processor 120 may extract clip data configured in public to provide the clipboard regardless of the account logged in the electronic device 101. For example, the processor 120 may provide the clipboard by extracting clip data configured in public with respect to all the logged-in accounts regardless of the user account or other accounts.

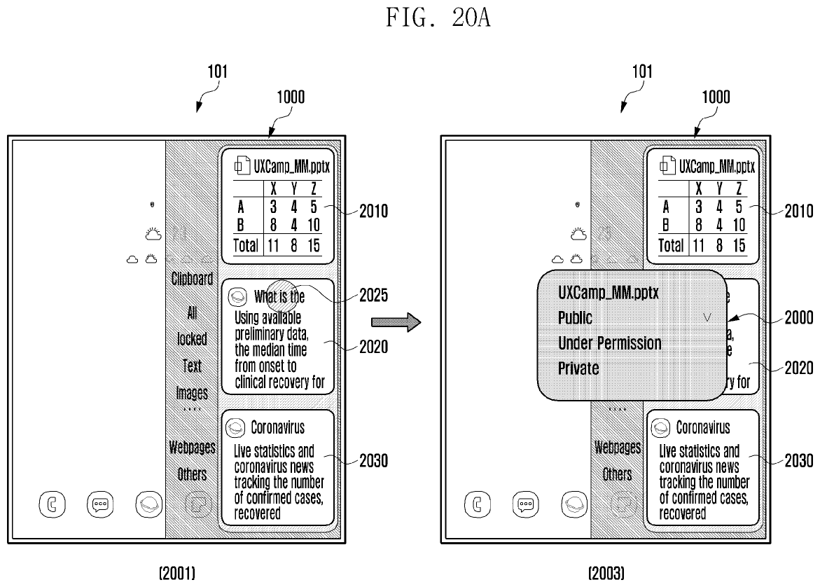

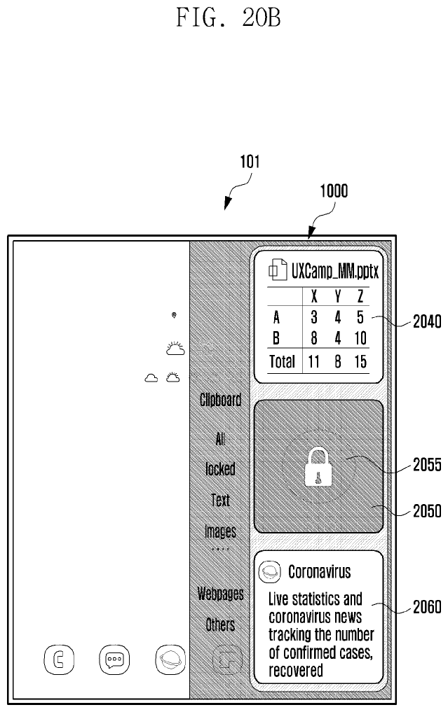

FIGS. 20A and 20B are diagrams illustrating an example of providing a clipboard in an electronic device according to various embodiments.

According to an embodiment, FIGS. 20A and 20B may illustrate an operation example for providing, for example a case where several different users use the electronic device 101 as a common device or a user uses the electronic device 101 with multiple user accounts, an account-based clipboard.

Referring to FIG. 20A, FIG. 20A may illustrate an example of configuring a policy (or importance) for clip data of the clipboard 1000.

According to an embodiment, as illustrated in example screen 2001, the electronic device 101 may display the clipboard 1000 including a plurality of pieces of clip data 2010, 2020, and 2030. According to an embodiment, the user may perform a designated user interaction for configuring a policy (e.g., an exposure degree) to at least one clip data among the plurality of pieces of clip data 2010, 2020, and 2030 of the clipboard 1000.

For example, as illustrated in example screen 2025, the user may perform a designated user input 2025 (e.g., a long press input) for designating any one clip data 2020 of the clipboard 1000 and calling a policy menu 2000. According to some embodiments, the user may configure individual policies based on individual selection of clip data 2010, 2020, and 2030 in the clipboard 1000, or may configure a collective policy based on the collective selection of all the clip data 2010, 2020, and 2030.

According to an embodiment, as illustrated in example screen 2003, the electronic device 101 may provide the policy menu 2000 based on the designated clip data 2020 in response to the user input 2025. According to an embodiment, the policy menu 2000 may include, for example, a first item (e.g., “Public” item), a second item (e.g., “under Permission” item), and a third item (e.g., “Private” item) as a menu for configuring a security level of clip data.

According to an embodiment, a first policy (e.g., Public) by the first item may indicate settings of a policy (e.g., public to all) corresponding to “low” of the security level (or importance) as providing the clipboard on a public basis. For example, when the policy is configured based on the first item, corresponding at least one piece of clip data may be provided on a public basis regardless of a login account. For example, the policy (or security level) by the first item may indicate a policy that all logged-in users can access regardless of the account logged into the electronic device 101.

According to an embodiment, a second policy (e.g., under Permission) by the second item may indicate settings of a policy (e.g., a partial {or limited}) corresponding to “middle” of the security level (or importance) as providing the clipboard only to pre-registered (or permitted) additional accounts based on a user account and a logged-in user account.

For example, when the policy is configured based on the second item, the corresponding at least one piece of clip data may be provided based on permission limiting the logged-in account to the user account and/or the account pre-registered by the user account. For example, the policy (or security level) by the second item may indicate a policy allowing partial access to the clipboard at the time of login by the pre-registered (or permitted) account by the user, based on a user's permission account.

According to an embodiment, a third policy (e.g., Private) by the third item may indicate settings of a policy (e.g., private) corresponding to “high” of the security level (or importance) as providing the clipboard only to the user account. For example, when the policy is configured based on the third item, corresponding at least one piece of clip data may be provided only to a logged-in user account (e.g., a user account that generates the clip data). For example, the policy (or security level) by the third item may indicate a policy allowing access to the clipboard (e.g., the clip data generated by the user account) at the time of login by the user account, based on the user account.

Referring to FIG. 20B, 20B may illustrate an example of providing a clipboard based on a configured policy with respect to a case of a login with a different account in the electronic device 101. For example, in FIG. 20B, a case in which a user account-based policy (e.g., Private) is configured may be illustrated as an example.

According to an embodiment, a first user account logged into the electronic device 101 in FIG. 20A and a second user account logged into the electronic device 101 in FIG. 20B may be different from each other. According to an embodiment, as illustrated in FIG. 20B, the electronic device 101 may identify the logged-in user account, and may extract clip data related to the logged-in user account to provide the clipboard. For example, at the time of a login with the first user account, the first clip data 2010, 2020 and 2030 may be provided, and at the time of a login with the second user account, second clip data 2040, 2050 and 2060 may be provided.

According to some embodiments, when designated clip data (e.g., the clip data 2050) is configured in a private manner (or private settings) in the first user account, the second user account is logged in, and the entire policy settings of the clipboard is the first policy (e.g., Public) or the second policy (e.g., under Permission), the clip data 2050 configured in the private manner by the first user account may be secured and not shown on the clipboard 1000, or may be provided in a private state 2055 (or a locked state) as illustrated in FIG. 20B.

According to various embodiments, the electronic device 101 may provide an account-based clipboard (or a universal clipboard or cloud clipboard), and the user may individually or collectively configure importance (or security level) with respect to the clip data within the clipboard. For example, when the electronic device 101 is used as a common device shared by multiple users, the importance may be designated with respect to the clipboard or the clip data for security purposes, and the degree of exposure of the clipboard or the clip data may be differently provided in the common device depending on the importance.

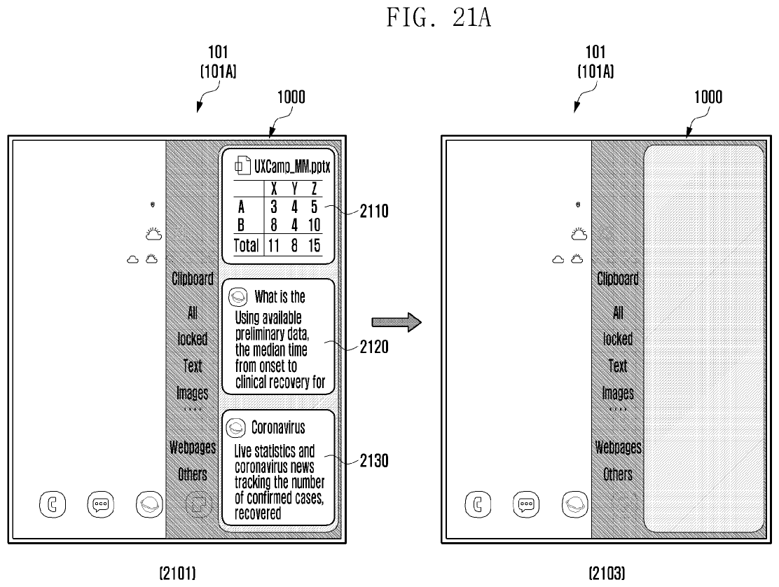

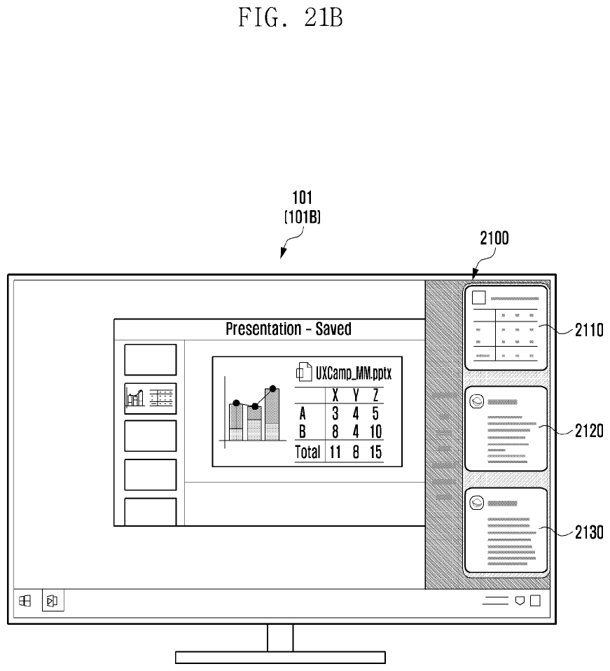

FIGS. 21A and 21B are diagrams illustrating an example of providing a clipboard in an electronic device according to various embodiments.

According to an embodiment, FIGS. 21A and 21B may illustrate an operation example of providing an account-based clipboard with respect to a case of logging out of a user account in the electronic device 101 (e.g., the first electronic device 101A).

Referring to FIG. 21A, an example of configuring the security of clip data of the clipboard 1000 and providing the clipboard 1000 in a case of logging out of a user account in the electronic device 101 (e.g., the first electronic device 101A) is illustrated.

According to an embodiment, as illustrated in example screen 2101, the electronic device 101 may display the clipboard 1000 including a plurality of pieces of clip data 2110, 2120, and 2130. According to an embodiment, as illustrated in example 2101, the user may log out of a user account in the electronic device 101 while using the electronic device 101.

According to an embodiment, as illustrated in example screen 2103, when detecting that the user has logged out of the user account, the electronic device 101 may provide the clipboard 1000 based on the user account by configuring security. For example, the electronic device 101 may collectively delete clip data 2110, 2120, and 2130 generated based on the user account from the clipboard 1000. According to an embodiment, collective deletion of the clip data 2110, 2120, and 2130 according to the logout of the user account may not be actual deletion from the memory 130, and may indicate, for example, hiding the clip data (removing display) in the clipboard 1000.

Referring to FIG. 21B, FIG. 21B may illustrate an example of providing a clipboard 2100 in the electronic device 101 (e.g., the second electronic device 101B) logged in with a user account. For example, in FIG. 21B, the user account may be in a logout state in the first electronic device 101A and the user account may be in a login state in the second electronic device 101B.

According to an embodiment, as illustrated in FIG. 21B, the electronic device 101 (e.g., the second electronic device 101B) may provide the clipboard 2100 based on the login user account. For example, the clipboard 2100 may be provided including clip data 2110, 2120, and 2130 generated based on the user account. For example, the clipboards 1000 and 2100 that are linked based on the user account may operate in conjunction with a universal clipboard (or a cloud clipboard), and the clip data 2110, 2120, and 2130 may be provided according to the login state or logout state of the user account. For example, the electronic device 101 in the logged-out state (e.g., the first electronic device 101A) may provide the clipboard 1000 excluding all of the clip data 2110, 2120, and 2130, and the electronic device 101 in the logged-in state (e.g., the second electronic device 101B) may provide the clipboard 2100 including (or displaying) all of the clip data 2110, 2120, and 2130.

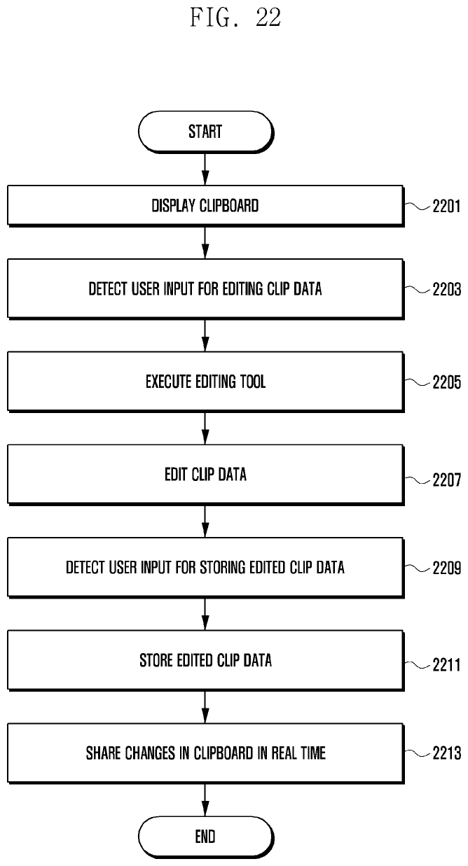

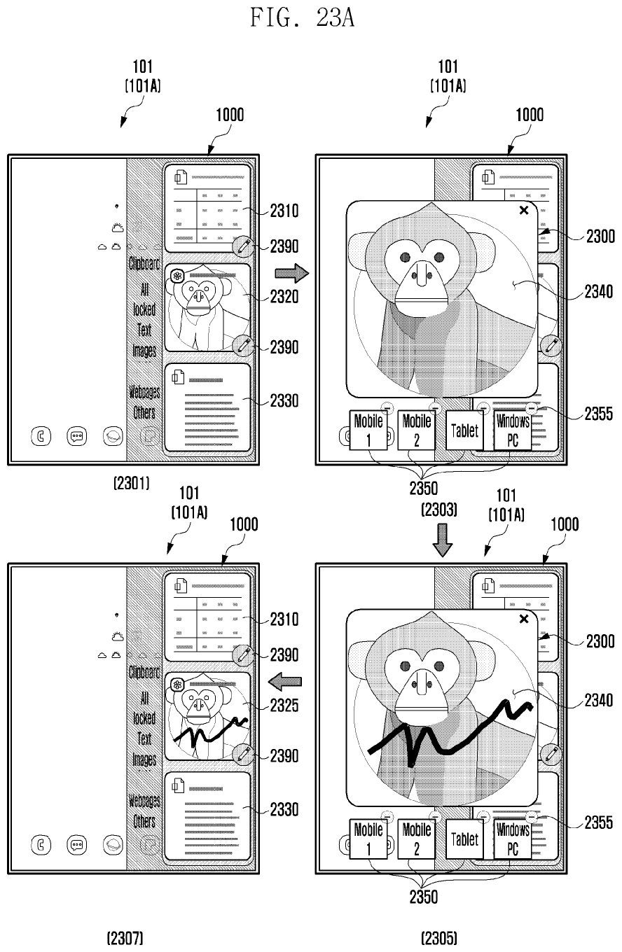

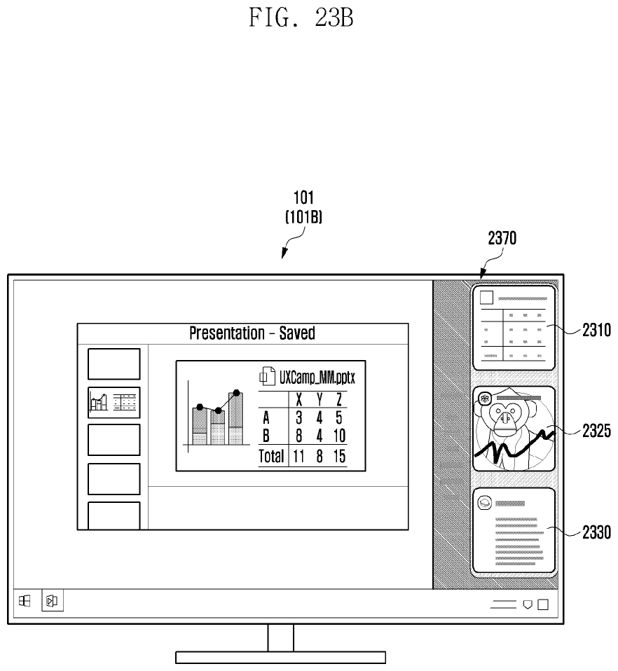

FIG. 22 is a flowchart illustrating an operating method of an electronic device according to various embodiments. FIGS. 23A and 23B are diagrams illustrating an example of providing a clipboard in an electronic device according to various embodiments.

According to an embodiment, in FIGS. 22, 23A, and 23B, an operation example of sharing (e.g., account-based sharing or synchronization) changes in the clipboard 1000 based on a user account in the electronic device 101 (e.g., the first electronic device 101A) is illustrated. For example, in FIG. 22, when the clip data is changed (e.g., edited) in the electronic device 101 (e.g., the first electronic device 101A) and stored in the clipboard of the electronic device 101, an example of sharing (e.g., account-based sharing or synchronization) the clip data changed in the clipboard with another electronic device 101 (e.g., the second electronic device 101B) based on the user account may be shown.

Referring to FIG. 22, in operation 2201, the processor 120 of the electronic device 101 may display a clipboard. According to an embodiment, the processor 120 may call and display the clipboard based on a designated user input related to the clipboard call. According to an embodiment, the clipboard may include a plurality of pieces of clip data clipped by the user.

In operation 2203, the processor 120 may detect a user input for editing at least one piece of clip data in the clipboard. According to an embodiment, a user may input a designated user interaction (e.g., a user input) to execute the clipboard and edit the at least one piece of clip data among the clip data of the clipboard. An example of this is illustrated in example screen 2301 of FIG. 23A.

Referring to FIG. 23A, as illustrated in example screen 2301, the user may input a user input that designates clip data 2320 for editing among a plurality of pieces of clip data 2310, 2320, and 2330 provided through the clipboard 1000, based on the corresponding clip data 2320. According to an embodiment, the user input may include an input for instructing the clip data 2320 to be edited on the clip data 2320. According to an embodiment, the electronic device 101 may provide an edition object 2390 for the clip data (e.g., clip data 2310 and clip data 2320) editable on the clipboard 1000, and may receive a user input for editing corresponding clip data from the edition object 2390.

In operation 2205, the processor 120 may execute an editing tool (e.g., an editing application) capable of editing clip data based on a user input. According to an embodiment, the processor 120 may identify the editing tool that can be edited based on the attribute of the designated clip data, and may execute the identified editing tool. According to an embodiment, the processor 120 may display the designated clip data (e.g., a clip object of the clip data) based on the execution of the editing tool. An example of this is illustrated in example screen 2303 of FIG. 23A.

Referring to FIG. 23A, as illustrated in example screen 2303, the electronic device 101 may provide an execution screen of an editing tool 2300 on an execution screen on which the clipboard 1000 is displayed, in an overlapping or floating manner According to an embodiment, the editing tool 2300 may display a clip object 2340 (e.g., image) of the clip data 2320 designated by the user, and may include and provide a variety of editing tools (not shown) for supporting the editing of the user.

According to an embodiment, based on the editing tool 2300, the electronic device 101 may provide a sharing target designation object 2350 capable of configuring a sharing (or synchronizing) target of the edited clip data. According to an embodiment, the sharing target designation object 2350 may be provided to correspond to at least one electronic device 101 (e.g., a first electronic device, a second electronic device, a third electronic device, and a fourth electronic device) designated to share (or synchronize) the clipboard based on the user account.

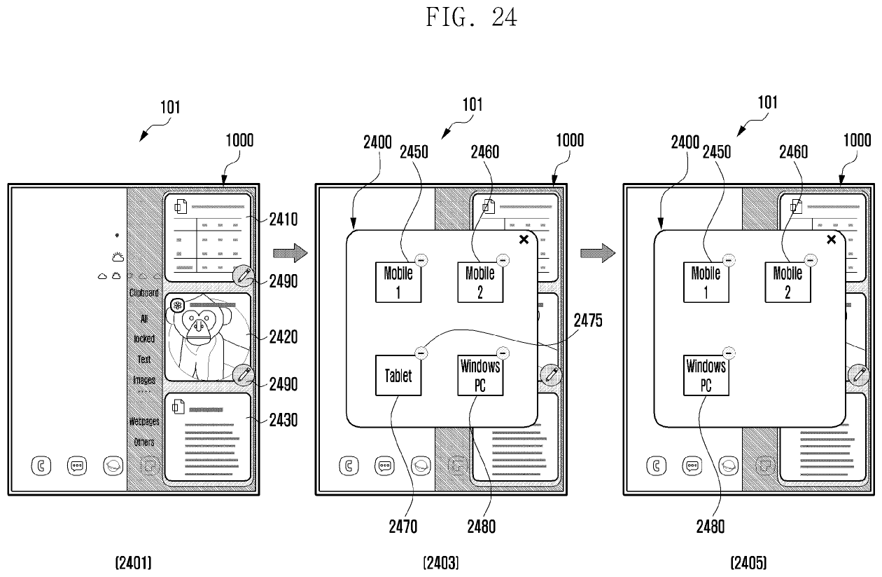

According to an embodiment, FIG. 23A may illustrate an example in which four electronic devices are connected (or synchronized) based on the user account. According to an embodiment, the user may select an electronic device to be excluded from sharing (or synchronizing) the edited clip data based on selection of an excluded object 2355 from the sharing target designation object 2350. According to an embodiment, an example of configuring a sharing target will be described with reference to FIG. 24 to be described later.

In operation 2207, the processor 120 may edit the clip data. According to an embodiment, the processor 120 may edit the clip data based on a user input for clip data (e.g., a clip object) displayed through the editing tool. An example of this is shown in example screen 2305 of FIG. 23A.

Referring to FIG. 23A, as illustrated in example screen 2305, the user may edit the clip object 2340 displayed through the editing tool 2300 using a designated editing tool.

In operation 2209, the processor 120 may detect a user input for storing the edited clip data. According to an embodiment, when editing of the clip data is completed, the user may perform a designated user input for terminating the editing tool or a designated user input for applying (e.g., store) the edited clip data to the clipboard.

In operation 2211, the processor 120 may store the edited clip data based on the detection of the user input for storing the edited clip data. According to an embodiment, the processor 120 may store the edited clip data in the clipboard 1000 in response to the user input (e.g., an input instructing to store the edited clip data). An example of this is illustrated in example screen 2307 of FIG. 23A.

Referring to FIG. 23A, as illustrated in example screen 2307, edited clip data 2325 may be applied to the clipboard 1000 and provided. According to an embodiment, the electronic device 101 may update or replace the existing clip data 2320 to the edited clip data 2325 on the clipboard 1000 and provide the updated clip data. According to an embodiment, the electronic device 101 may maintain the existing clip data 2320 in the clipboard 1000 and may add and provide the edited clip data 2325. For example, when the clip data of the clipboard 1000 is edited, the electronic device 101 may maintain or delete the corresponding existing clip data 2320 and may provide the edited clip data 2325.

In operation 2213, the processor 120 may share (or synchronize) changes (or updated contents) of the clipboard in real time. According to an embodiment, the processor 120 may share the changes of the clipboard so that the clip data edited in the clipboard can be also applied to the clipboard of another electronic device 101 connected based on the user account. According to an embodiment, the clipboard of the electronic device 101 may be linked with a cloud (e.g., a cloud clipboard) based on the user account. According to an embodiment, when the clipboard in the electronic device 101 (e.g., the first electronic device, the second electronic device, the third electronic device, and the fourth electronic device) is updated (e.g., clip data is added, changed, and/or or deleted), the updated contents may be equally applied to the clipboard of each electronic device 101. An example of this is illustrated in FIG. 23B.

Referring to FIG. 23B, FIG. 23B may illustrate an example of providing a clipboard 2370 in the electronic device 101 (e.g., the second electronic device 101B) connected with a user account. For example, FIG. 23B may illustrated an example in which the clip data 2325 edited in the first electronic device 101A is equally applied (e.g., synchronized) to the second electronic device 101B. For example, the updated contents of the first electronic device 101A may also be shared with the second electronic device 101B.

According to an embodiment, the electronic device 101 (e.g., the first electronic device, the second electronic device, the third electronic device, and the fourth electronic device) based on the user account may be synchronized with the clipboards 1000 and 2370 connected to each other, and the electronic device 101 may support to edit (e.g., add, change, and/or delete) the clip data through the clipboards 1000 and 2370. According to an embodiment, when the clip data is edited in one electronic device, the user account-based electronic device 101 may share (or synchronize) corresponding update content between the user account-based electronic devices 101 to reflect the shared information in real time.

FIG. 24 is a diagram illustrating an example of configuring a synchronization target of a clipboard in an electronic device according to various embodiments.

According to an embodiment, FIG. 24 may illustrate an example of configuring another electronic device 101 based on a user account to share clip data of a clipboard in the electronic device 101.

Referring to FIG. 24, as illustrated in example screen 2401, the electronic device 101 may display a clipboard 1000 including a plurality of pieces of clip data 2410, 2420, and 2430. According to an embodiment, the electronic device 101 may call and display the clipboard based on a designated user input related to the clipboard call.

According to an embodiment, the electronic device 101 may provide an editing object 2490 for clip data (e.g., the clip data 2410 and the clip data 2420) editable on the clipboard 1000. For example, the electronic device 101 may receive a user input for editing corresponding clip data from the editing object 2490.

According to an embodiment, the editing object 2490 may be an object for entering a target designation mode to configure a sharing (or synchronization) target of the clip data, as in the example of FIG. 24. According to some embodiments, as illustrated in FIG. 23A, the editing object 2490 may be replaced with an object for entering an editing mode for editing clip data, and may provide a corresponding interface.

According to an embodiment, in the state illustrated in example screen 2401, the user may perform a user input for configuring sharing targets of the plurality of clip data 2310, 2320, and 2330 provided through the clipboard 1000. According to some embodiments, the user input may include a user input (e.g., an editing object 2490 selection input) for configuring a sharing target of corresponding clip data based on the editing object 2490.

According to an embodiment, as illustrated in example screen 2403, the electronic device 101 may provide an execution screen of an editing tool 2400 in an overlapping or floating manner on an execution screen on which the clipboard 1000 is displayed. According to an embodiment, the editing tool 2400 may include a tool capable of configuring a sharing (or synchronization) target of at least one piece of clip data designated by a user. According to an embodiment, the editing tool 2400 may provide sharing target designation objects (e.g., a first object 2450, a second object 2460, a third object 2470, and a fourth object 2480).

According to an embodiment, the sharing target designation objects (e.g., the first object 2450, the second object 2460, the third object 2470, and the fourth object 2480) may be provided to correspond to at least one electronic device 101 (e.g., a first electronic device, a second electronic device, a third electronic device, and a fourth electronic device) designated to share (or synchronize) the clip board based on a user account. According to an embodiment, FIG. 24 may illustrate an example in which fourth electronic devices (e.g., the first electronic device, the second electronic device, the third electronic device, and the fourth electronic device) are connected (or synchronized) based on a user account.

According to an embodiment, the user may exclude the corresponding electronic device (e.g., the third electronic device) from the sharing (or synchronization) target of the clip data based on selection of the excluded object (e.g., the excluded object 2475 of the third object 2470) from the sharing target designation objects (e.g., the first object 2450, the second object 2460, the third object 2470, and the fourth object 2480). An example of this is illustrated in example screen 2405.

According to an embodiment, as illustrated in example screen 2405, the electronic device 101 may provide the first object 2450, the second object 2460, and the fourth object 2480 except for the third object 2470 in the existing sharing target designation objects (e.g., the first object 2450, the second object 2460, the third object 2470, and the fourth object 2480) of the editing tool 2400.

According to an embodiment, FIG. 24 may illustrate an example of providing a list of the electronic devices 101 based on a user account and configuring a sharing target based on the list. According to some embodiments, the list of the electronic devices 101 of the sharing target designation objects may be provided as a list of the electronic devices that use the corresponding clip data while operating in the method shown in FIG. 24. For example, the electronic device 101 may identify in which electronic device the corresponding clip data is being used or synchronized, and based on the identification result, may provide the corresponding electronic device list as the sharing target designation object.

According to an embodiment, in examples of FIGS. 23A and 24, the operation of excluding the electronic device to share the clip data has been described as an example, but various embodiments are not limited thereto. For example, electronic devices to share the clip data may be added based on operations corresponding to FIGS. 23A and 24. For example, the electronic device 101 may exclude or add a sharing target electronic device of the clip data based on an interface capable of configuring the sharing target electronic device of the clip data.

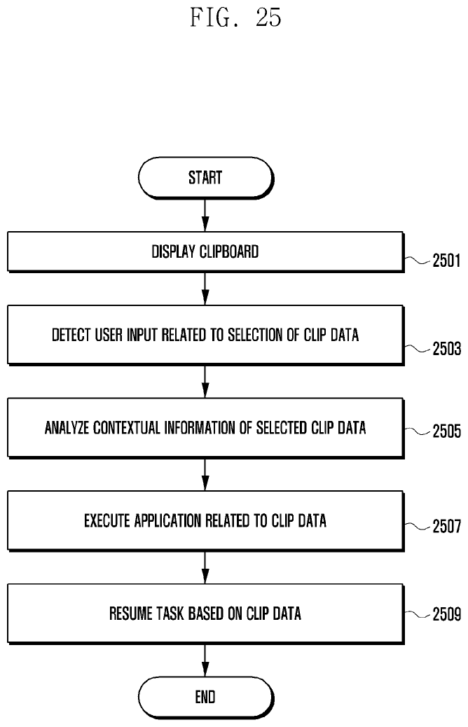

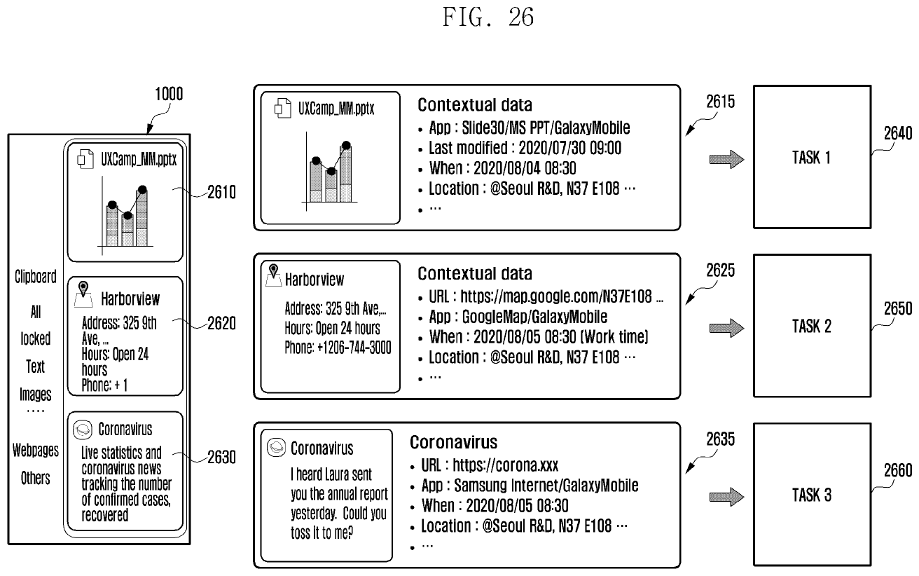

FIG. 25 is a flowchart illustrating an operating method of an electronic device according to various embodiments. FIG. 26 is a diagram illustrating an example of utilizing clip data of a clipboard in an electronic device according to various embodiments.

According to an embodiment, FIGS. 25 and 26 may illustrate an operation example of supporting to resuming a previous task of a user based on clip data in an electronic device 101 according to various embodiments.

Referring to FIG. 25, in operation 2501, the processor 120 of the electronic device 101 may display a clipboard. According to an embodiment, the processor 120 may call and display the clipboard based on a designated user input related to the clipboard call. According to an embodiment, the clipboard may include a plurality of pieces of clip data clipped by the user.

In operation 2503, the processor 120 may detect a user input related to selection of at least one piece of clip data from the clipboard. According to an embodiment, a user may execute the clipboard, and may perform a designated user interaction for selecting at least one piece of clip data among the plurality of pieces of clip data of the clipboard and resuming a task. An example of this is illustrated in FIG. 26.

Referring to FIG. 26, the electronic device 101 may display the clipboard 1000 including a plurality of pieces of clip data (e.g., first clip data 2610, second clip data 2620, and third clip data 2630). According to an embodiment, the user may select clip data related to the user's task resumption among the clip data 2610, 2620, and 2630 of the clipboard 1000.

In operation 2505, the processor 120 may analyze contextual information of the clip data selected based on the user input. According to an embodiment, when the clip data is selected, the processor 120 may analyze contextual information of the clip data. An example of this is illustrated in FIG. 26.

Referring to FIG. 26, the clip data 2610, 2620, and 2630 of the clipboard 1000 may include corresponding contextual information (e.g., first contextual information 2615, second contextual information 2625, and third contextual information 2635), respectively. According to an embodiment, the electronic device 101 may extract and analyze the contextual information 2615, 2625, and 2635 of the selected clip data based on the user's selection of the clip data.

In operation 2507, the processor 120 may execute an application related to the clip data. According to an embodiment, the processor 120 may identify and execute the application related to the clip data based on the contextual information of the clip data.

In operation 2509, the processor 120 may resume the user's task based on the clip data. According to an embodiment, the processor 120 may resume a task consecutive to the previous task in the executed application. For example, the processor 120 may provide an execution screen in a state in which the previous task has been performed in the corresponding application, based on the contextual information. An example of this is illustrated in FIG. 26.

Referring to FIG. 26, when clip data 2610, 2620, and 2630 are selected by the user from the clipboard being displayed and it is determined to resume the task based on the selection of the clip data 2610, 2620, and 2630 of the user, the electronic device 101 may execute the task by the clip data based on the corresponding contextual information 2615, 2625, and 2635, respectively. For example, the user may use the clipboard 1000 in the electronic device 101 to consecutively perform the previously performed task (e.g., see Tasks 2640, 2650, 2660).

According to an embodiment, the electronic device 101 may analyze the first contextual information 2615 based on the user's selection of the first clip data 2610, and may execute a first application (e.g., a document application) determined according to the first contextual information 2615. According to an embodiment, the electronic device 101 may analyze a context from the first application to the previous task based on the first contextual information 2615, and may display an execution screen (e.g., a document work screen in a state of performing up to the previous task) of the first application by calling a corresponding document (e.g., a work file).

According to an embodiment, the electronic device 101 may analyze the second contextual information 2625 based on the user's selection of the second clip data 2620, and may execute a second application (e.g., a map application) determined according to the second contextual information 2625. According to an embodiment, the electronic device 101 may analyze a context up to the previous task based on the second contextual information 2625 in the second application, and may analyze corresponding map and location information to display an execution screen (e.g., a map screen in a state of performing up to the previous task) of the second application.

According to an embodiment, the electronic device 101 may analyze the third contextual information 2635 based on the user's selection of the third clip data 2630, and may execute a third application (e.g., a browser application) determined according to the third contextual information 2635. According to an embodiment, the electronic device 101 may analyze a context up to the previous task based on the third contextual information 2635 in the third application, and may call a corresponding webpage (e.g., URL access) to display an execution screen (e.g., a webpage screen in a state of performing up to the previous task) of the third application.

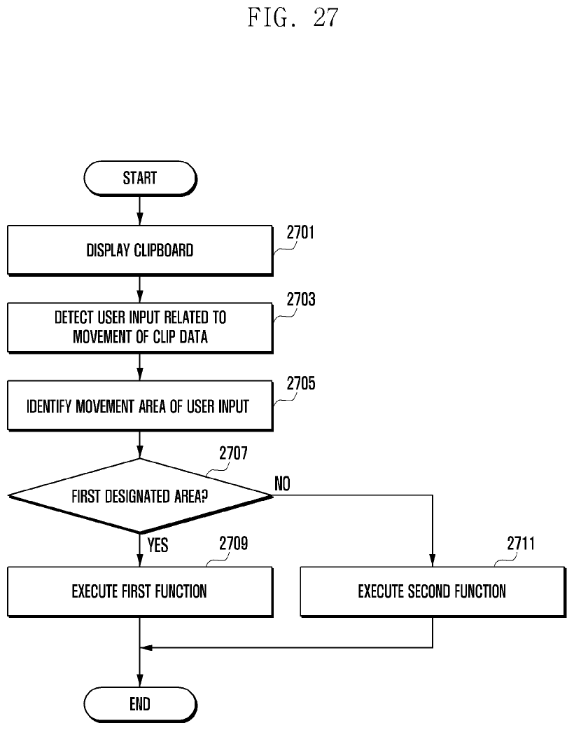

FIG. 27 is a flowchart illustrating an operating method of an electronic device according to various embodiments.

According to an embodiment, FIG. 27 may illustrate an example of operating (e.g., function execution) clip data based on an area in which clip data of a clipboard is moved (e.g., drag & drop) on an execution screen of an application in the electronic device 101.

Referring to FIG. 27, in operation 2701, the processor 120 of the electronic device 101 may display a clipboard. According to an embodiment, the processor 120 may call and display the clipboard based on a designated user input related to the clipboard call. According to an embodiment, the clipboard may include a plurality of pieces of clip data clipped by the user.

In operation 2703, the processor 120 may detect a user input related to the movement of the clip data. According to an embodiment, the processor 120 may detect a user input in which designated clip data is moved from the clipboard into an execution screen (e.g., drag & drop).

In operation 2705, the processor 120 may identify a movement area where the user input is moved based on the detection of the user input. According to an embodiment, the processor 120 may identify an area in which the designated clip data is moved within the execution screen from the clipboard. According to an embodiment, the area in which the clip data is moved within the execution screen may be classified into, for example, a first designated area (e.g., an input area {or an input field}) corresponding to an application execution screen on the execution screen, and a second designated area (e.g., other areas {e.g., an edge area, an empty area (or desktop area), or a task bar area} other than the input area) corresponding to areas other than the application execution screen on the execution screen.

In operation 2707, the processor 120 may determine whether the area in which the clip data is moved is the first designated area or the second designated area, based on the identification result. According to an embodiment, the processor 120 may track location information where the clip data is moved (e.g., drag & drop), and may determine whether the final movement area of the clip data corresponds to the first designated area or the second designated area based on the tracked location information.

In operation 2707, when it is determined that the final movement area corresponds to the first designated area (e.g., “YES” in operation 2707), in operation 2709, the processor 120 may execute a first function. According to an embodiment, when the clip data is moved to the input area, the processor 120 may execute a function of pasting the clip data.

In operation 2709, when it is determined that the final movement area corresponds to the second designated area (e.g., “NO” in operation 2707), the processor 120 may execute a second function in operation 2711. According to an embodiment, when the clip data is moved to areas other than the input area (e.g., the edge area or the empty area {e.g., the desktop screen}), the processor 120 may perform a function of resuming a task based on the clip data.

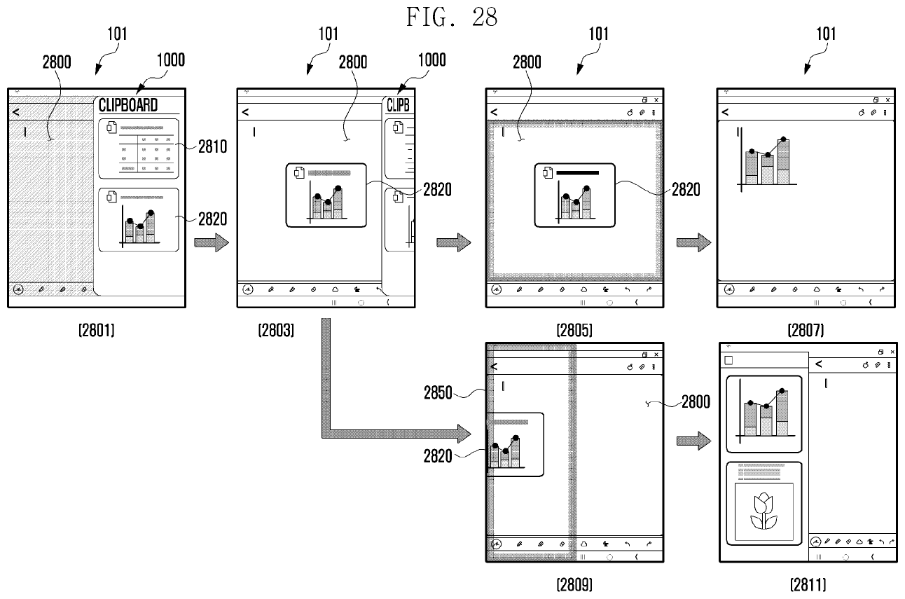

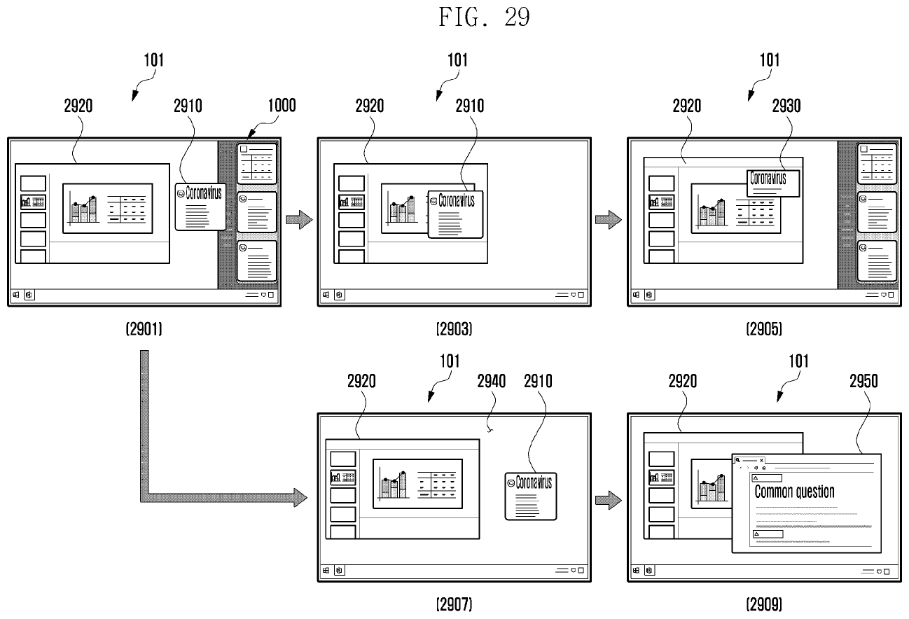

According to an embodiment, an operation of executing another function based on the area where the clip data is dragged and dropped from the clipboard is illustrated in FIGS. 28 and 29.

FIG. 28 is a diagram illustrating an example of operating clip data of a clipboard in an electronic device according to various embodiments.

Referring to FIG. 28, FIG. 28 may illustrate an example of executing a corresponding function (e.g., operating clip data) based on the fact that clip data of the clipboard 1000 is dragged and dropped to a first designated area (e.g., an input area) or a second designated area (e.g., an edge area) in the electronic device 101.

According to an embodiment, as illustrated in example screen 2801, the electronic device 101 may display the clipboard 1000 including a plurality of pieces of clip data 2810 and 2820. According to an embodiment, the electronic device 101 may provide (e.g., display) the clipboard 1000 on an execution screen 2800 through a designated area of the display module 160 comprising a display. For example, the processor 120 may overlap and provide the clipboard 1000 on the execution screen 2800, provide the clipboard 1000 in a pop-up form by a pop-up window, or may provide the clipboard 1000 in a split area by a split window.

According to an embodiment, as illustrated in example screen 2803, the user may select the clip data 2820 from the clipboard 1000 and move the selected clip data 2820 to the execution screen 2800. According to an embodiment, the user may drag the clip data 2820 to the first designated area or the second designated area according to the purpose to use the clip data 2820 and may then drop the clip data 2820 to a desired location. According to an embodiment, in response to the fact that the clip data 2820 is selected from the clipboard 1000 and dragged to the execution screen 2800, the electronic device 101 may frame out (e.g., slide out) the clipboard 1000 in a designated direction, and may provide an effect of removing the clipboard 1000 from the screen in response to the fact that the clip data is dropped.

According to an embodiment, as illustrated in example screen 2805, the user may drop the dragged clip data 2820 from the execution screen 2800, for example, the first designated area (e.g., the input area). According to an embodiment, as illustrated in example screen 2807, when the clip data 2820 is dropped to the first designated area, the electronic device 101 may execute a first function of pasting the clip data 2820 (e.g., a clip object of the clip data 2820) to the execution screen 2800.

According to an embodiment, as illustrated in example screen 2809, the user may drop the dragged clip data 2820 from another area 2850 other than the execution screen 2800, for example, the second designated area (e.g., the edge area). According to an embodiment, as illustrated in example screen 2811, when the clip data 2820 is dropped to the second designated area, the electronic device 101 may execute a function of resuming the previous task based on the clip data 2820. According to some embodiments, the electronic device 101 may provide an execution screen based on the clip data 2820 according to the resumption of the task based on the split screen or the pop-up window.

FIG. 29 is a diagram illustrating an example of operating clip data of a clipboard in an electronic device according to various embodiments.

Referring to FIG. 29, FIG. 29 may illustrate an example of executing a corresponding function (e.g., operating clip data) based on the fact that clip data of the clipboard 1000 is dragged and dropped to a first designated area (e.g., an input area {or an input field}) or a second designated area (e.g., an empty area {or a desktop area} and/or a task bar area) in the electronic device 101.

According to an embodiment, as illustrated in example screen 2901, the electronic device 101 may display the clipboard 1000 including a plurality of pieces of clip data. According to an embodiment, the electronic device 101 may provide (e.g., display) the clipboard 1000 through a designated area of the display module 160.

According to an embodiment, the user may select clip data 2910 from the clipboard 1000 and may move the selected clip data 2910 to the outside of the clipboard 1000. According to an embodiment, the user may drag the clip data 2910 to a first designated area or a second designated area according to a purpose to use the clip data 2910 and may then drop the clip data 2910 to a desired location. According to an embodiment, in response to the fact that the clip data 2910 is selected from the clipboard 1000 and dragged to the outside of the clipboard 1000, the electronic device 101 may frame out (or slide out) the clipboard 1000 in a designated direction, and may remove the clipboard 1000 from a corresponding screen in response to the fact that the clip data is dropped.

According to an embodiment, as illustrated in example screen 2903, the user may drop the dragged clip data 2910 from an execution screen 2920 of an application, for example, the first designated area (e.g., the input area). According to an embodiment, as illustrated in example screen 2905, when the clip data 2910 is dropped in the first designated area, the electronic device 101 may execute a first function of pasting the clip data 2910 (e.g., the clip object 2930 of the clip data 2910) to the execution screen 2920.

According to an embodiment, as illustrated in example screen 2907, the user may drop the dragged clip data 2910 on an area 2940 other than the execution screen 2920 of the application, for example, the second designated area (e.g., the empty area or the desktop). According to an embodiment, as illustrated in example screen 2909, when the clip data 2910 is dropped to the second designated area, the electronic device 101 may execute a second function of resuming the previous task based on the clip data 2910. According to some embodiments, the electronic device 101 may open a new window 2950 of the clip data 2910 according to the resumption of the task, and may provide a corresponding execution screen of the application based on the new window.

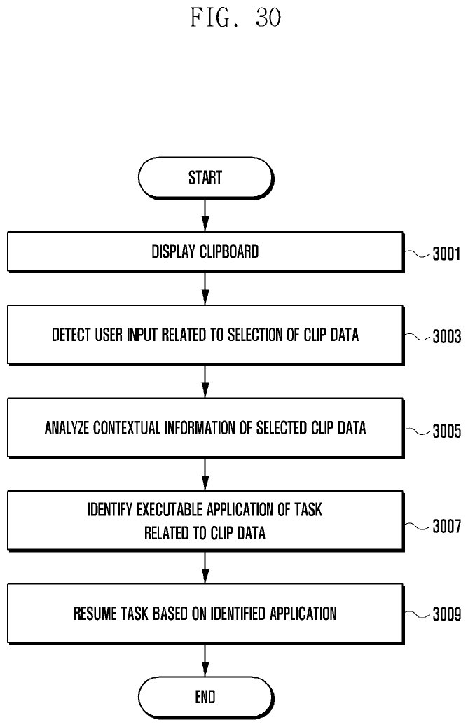

FIG. 30 is a flowchart illustrating an operating method of an electronic device according to various embodiments.

According to an embodiment, FIG. 30 may illustrate an operation example of supporting a user to resume a previous task based on an executable optimal application of a task related to clip data in the electronic device 101 according to various embodiments.

Referring to FIG. 30, in operation 3001, the processor 120 of the electronic device 101 may display a clipboard. According to an embodiment, the processor 120 may call and display the clipboard based on a designated user input related to the clipboard call. According to an embodiment, the clipboard may include a plurality of pieces of clip data clipped by the user.

According to an embodiment, the processor 120 may analyze a context related to a task currently being executed in the electronic device 101 when the clipboard is called. According to an embodiment, the processor 120 may analyze (or recognize) a context (or state) of an application currently being executed in the electronic device 101 and/or a task being performed in the executed application. For example, the processor 120 may the task-related context such as identification information (e.g., type, link {e.g., URL}, and/or name), a task being performed by an application, and/or a variety of contextual information (or TPO information) related to a user (or the electronic device 101) at the time of calling a clipboard.

According to an embodiment, the processor 120 may identify first contextual information based on context analysis related to the task. According to an embodiment, the processor 120 may understand the context of the current task through machine learning.

In operation 3003, the processor 120 may detect a user input related to selection of at least one piece of clip data from the clipboard. According to an embodiment, the user may execute the clipboard, and may perform a designated user interaction for performing task resumption by selecting at least one piece of clip data from the clip data of the clipboard.

In operation 3005, the processor 120 may analyze contextual information of clip data selected based on the user input. According to an embodiment, when the clip data is selected, the processor 120 may analyze application information related to the clip data based on the contextual information (e.g., second contextual information) of the clip data.

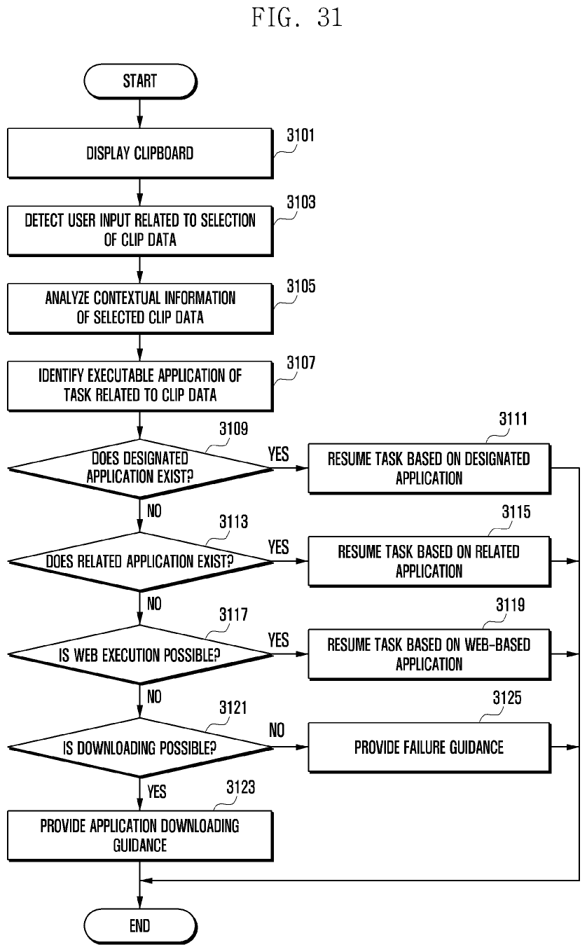

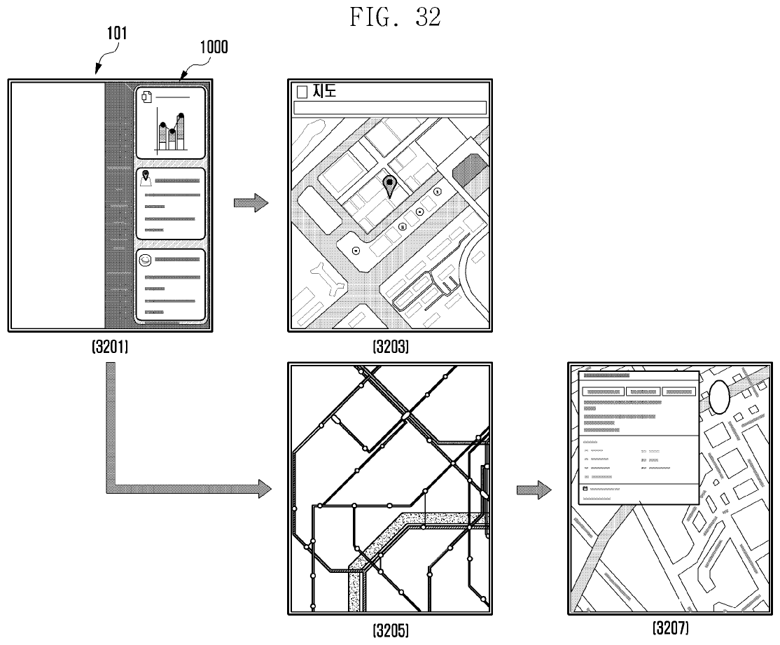

In operation 3007, the processor 120 may identify an executable application of the task related to the clip data. According to an embodiment, the processor 120 may identify an optimal application (e.g., an application designated in the clip data, a currently being executed application, or a replaceable related application) capable of executing the task related to the clip data based on the first contextual information and the second contextual information. An example of this is illustrated in FIGS. 31 and 32.

In operation 3009, the processor 120 may resume the user's task based on the clip data based on the identified application. According to an embodiment, the processor 120 may execute the identified application (e.g., the application designated in the clip data, the currently being executed application, or the replaceable related application), and may resume a task consecutive to a previous task in the executed application. For example, the processor 120 may provide an execution screen in a state of performing up to the previous task in the corresponding application based on the clip data.

FIG. 31 is a flowchart illustrating an operating method of an electronic device according to various embodiments.

According to an embodiment, FIG. 31 may illustrate an operation example of supporting a user to resume a previous task based on an executable optimal application of a task related to clip data in the electronic device 101 according to various embodiments.

Referring to FIG. 31, in operation 3101, the processor 120 of the electronic device 101 may display a clipboard. According to an embodiment, the processor 120 may call and display the clipboard based on a designated user input related to the clipboard call. According to an embodiment, the processor 120 may analyze a context related to a task currently being executed in the electronic device 101 when the clipboard is called.

According to an embodiment, the processor 120 may analyze (or recognize) a context (or state) of an application currently running in the electronic device 101 and/or a task being performed in the running application. For example, the processor 120 may the task-related context such as identification information (e.g., type, link {e.g., URL}, and/or name), a task being performed by an application, and/or a variety of contextual information (or TPO information) related to a user (or the electronic device 101) at the time of calling a clipboard. According to an embodiment, the processor 120 may identify first contextual information based on context analysis related to the task. According to an embodiment, the processor 120 may understand the context of the current task through machine learning.

In operation 3103, the processor 120 may detect a user input related to selection of at least one piece of clip data from the clipboard. According to an embodiment, the user may execute the clipboard, and may perform a designated user interaction for performing task resumption by selecting at least one piece of clip data from the clip data of the clipboard.

In operation 3105, the processor 120 may analyze contextual information of the clip data selected based on the user input. According to an embodiment, when the clip data is selected, the processor 120 may analyze application information related to the clip data based on the contextual information (e.g., the second contextual information) of the clip data.

In operation 3107, the processor 120 may identify an executable application of the task related to the clip data. According to an embodiment, the processor 120 may execute an optimal application (e.g., an application designated in the clip data, an application currently being executed, or a replaceable related application) capable of executing the task related to the clip data based on the first contextual information and the second contextual information.

In operation 3109, the processor 120 may determine whether a designated application capable of executing the task related to the clip data exists in the electronic device 101 based on the identification result of the application.

In operation 3109, when the designated application exists (e.g., “YES” in operation 3109), in operation 3111, the processor 120 may resume the user's task based on the clip data based on the designated application. For example, the processor 120 may execute the designated application and provide an execution screen in a state of performing up to the previous task based on the clip data in the designated application.

In operation 3109, when the designated application does not exist (e.g., “NO” in operation 3109), in operation 3113, the processor 120 may determine whether a related application exists. For example, when the designated application for executing the clip data does not exist in the electronic device 101, the processor 120 may use an alternative application (e.g., a related application or a web-based application) capable of replacing the designated application.

In operation 3113, when the related application exists (e.g., “YES” in operation 3113), in operation 3115, the processor 120 may resume the user's task based on the clip data based on the related application. For example, the processor 120 may execute the related application and provide an execution screen in a state of performing up to the previous task based on the clip data in the related application.

In operation 3113, when the related application does not exist (e.g., “NO” in operation 3113), in operation 3117, the processor 120 may determine whether web execution of clip data is possible. According to an embodiment, the processor 120 may determine whether the clip data can be executed by a web-based application. For example, the processor 120 may determine the web-based application as an alternative application capable of replacing the designated application.

In operation 3117, when web execution is possible (e.g., “YES” in operation 3117), in operation 3119, the processor 120 may resume the user's task based on the clip data based on the web-based application. For example, the processor 120 may execute the web-based application (e.g., a web map), and may provide an execution screen in a state of performing up to the previous task based on the clip data in the web-based application.

In operation 3117, when the web execution is not possible (e.g., “NO” in operation 3117), in operation 3121, the processor 120 may determine whether download and/or installation of the designated application from a store is possible. According to an embodiment, the processor 120 may determine whether the download and/or installation of the designated application is possible based on various contexts such as a communication state, whether an access to the store is possible, whether the designated application exists in the store, and/or whether to charge for downloading the designated application.

In operation 3121, when the download of the designated application is possible (e.g., “YES” in operation 3121), the processor 120 may provide a guidance related to downloading of the designated application in operation 3123. According to an embodiment, the processor 120 may download and install the designated application when the download is instructed by the user, and may provide an execution screen in a state of performing up to the previous task based on the clip data in the designated application.

When the downloading of the designated application is not possible (e.g., “NO” in operation 3121), in operation 3125, the processor 120 may provide a failure guidance in operation. According to an embodiment, the processor 120 may provide a guidance related to a failure in resuming the task based on the clip data. According to an embodiment, when providing the failure guidance, the processor 120 may also provide information about a cause of the failure in resuming the task.

FIG. 32 is a diagram illustrating an example of executing clip data in an electronic device according to various embodiments.

According to an embodiment, FIG. 32 may illustrate an operation example of supporting a user to resume a previous task based on an executable optimal application of a task related to clip data in the electronic device 101 according to various embodiments. Referring to FIG. 32, according to an embodiment, as illustrated in example screen 3201, the electronic device 101 may display the clipboard 1000 including at least one piece of clip data. According to an embodiment, the electronic device 101 may provide (e.g., display) the clipboard 1000 through a designated area of the display module 160. According to an embodiment, the user may select the clip data from the clipboard 1000.

According to an embodiment, when the clip data is selected, the electronic device 101 may analyze application information related to the clip data based on contextual information of the clip data. According to an embodiment, the electronic device 101 may identify an optimal executable application of the task related to the clip data based on a context related to an application currently being executed on the electronic device 101.

For example, the electronic device 101 may determine an application designated in the clip data or a currently executed application as an optimal application capable of executing the task related to the clip data, and may resume the task based on the determined application. According to an embodiment, the electronic device 101 may perform an application identification operation or a paste operation of a clip object of the clip data based on a designated area where the selected clip data is moved (e.g., drag & drop).

According to an embodiment, as illustrated in example screen 3203, when the designated application (e.g., primary application) for executing the task related to the clip data is configured in the electronic device 101, the electronic device 101 may execute the designated application and may resume the task consecutive to the previous task to provide a related execution screen.

According to an embodiment, as illustrated in example screen 3205, another application may be executed in the electronic device 101 at the time of resuming the task of the electronic device 101, and the other application may be an application (e.g., an alternative application) capable of executing the task related to the clip data.

According to an embodiment, when the other application is executed in the electronic device 101 at the time of resumption of the task and the other application is the application (e.g., the alternative application) capable of executing the task related to the clip data, as illustrated in example screen 3207, the electronic device 101 may resume the task consecutive to the previous task by using the alternative application (e.g., the other application currently being executed). For example, the electronic device 101 may resume the task based on the currently executed application without a transition of the application for the clip data.

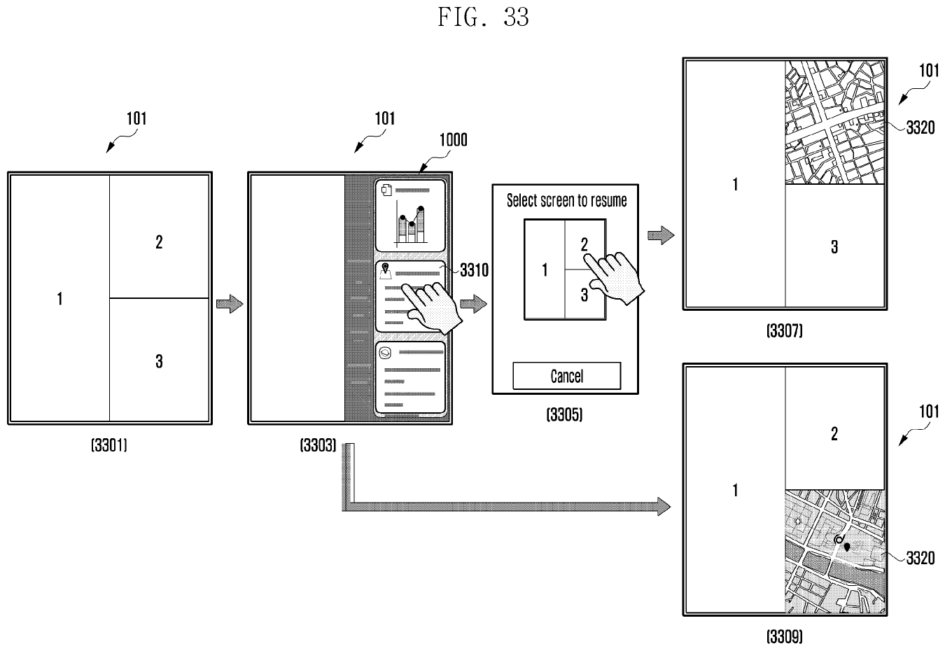

FIG. 33 is a diagram illustrating an example of utilizing clip data in a clipboard in an electronic device according to various embodiment.

According to an embodiment, FIG. 33 may illustrate an example of providing clip data based on a window on which clip data of a clipboard is moved (e.g., drag & drop) in a multi-window execution environment of the electronic device 101.

Referring to FIG. 33, according to an embodiment, as illustrated in example screen 3301, the electronic device 101 may be in an operating state based on multiple windows.

According to an embodiment, as illustrated in example screen 3303, the electronic device 101 may display the clipboard 1000 including at least one piece of clip data. According to an embodiment, the electronic device 101 may provide (e.g., display) the clipboard 1000 through a designated area of the display module 160. For example, the processor 120 may provide the clipboard 1000 by overlaying the clipboard 1000 on the multiple windows, or may provide the clipboard 1000 in a pop-up form by a pop-up window.

According to an embodiment, as illustrated in example screen 3303, when the user selects clip data 3310 from the clipboard 1000, the electronic device 101 may provide clip data 2310 based on a user selection-based window or a designated priority-based window. For example, when resuming a task based on the clip data in a multi-window environment, the electronic device 101 may execute the task through a designated window of the multiple windows rather than the entire screen.

According to an embodiment, in the case of the user selection-based window method, as illustrated in example screen 3305, the electronic device 101 may receive a user input of designating a window for executing the clip data 3310 (e.g., resuming the task) or a user input of moving (e.g., drag & drop) the clip data 3310 to one window of the multiple windows. According to an embodiment, as illustrated in example screen 3307, the electronic device 101 may resume and provide the task 3320 by the clip data 3310 through a designated window (e.g., window 2) based on the user input.

According to an embodiment, in the case of the designated priority-based window method, as illustrated in example screen 3309, the electronic device 101 may resume and provide the task 3320 by the clip data 3310 through a window (e.g., a window {or a screen} having a high priority) (e.g., window 3) selected according to a separate criterion.

An operating method performed in the electronic device 101 according to various embodiments may include detecting a first user input for a clip of designated content while displaying an execution screen of an application, generating clip data including a clip object and contextual information related to the content based on the first user input and storing the generated clip data in a memory, detecting a second user input related to a clipboard call, analyzing a task currently being performed in the electronic device based on the detection of the second user input, calling a clipboard based on the detection of the second user input, extracting clip data corresponding to the task from among a plurality of pieces of clip data of the clipboard, and providing a clipboard based on the clip data corresponding to the task through a display module. “Based on” as used herein covers based at least on.

According to an example embodiment, the clip data may include the clip object related to designated contents and contextual information related to the clip object.

According to an example embodiment, the contextual information may include a type of the clip object, identification information of an application, a task being performed by the application, and/or contextual information related to a user at the time of clip operation.

The various example embodiments disclosed in the specification and drawings are only presented as specific examples to easily explain the technical content of the disclosure and help understanding of the disclosure, and are not intended to limit the scope of the disclosure. Therefore, the scope of the disclosure should be construed as including all changes or modified forms derived based on the technical spirit of the disclosure in addition to the embodiments disclosed herein. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
a display;
a memory; and
a processor operatively connected to the display and the memory,
wherein the processor is configured to:
detect a first user input for a clip comprising designated content while displaying an execution screen of an application;
generate clip data comprising a clip object and contextual information related to the content based on the first user input and store the generated clip data in the memory;
detect a second user input related to calling a clipboard;
analyze a task being performed in the electronic device based on detection of the second user input;
call the clipboard based on detection of the second user input;
extract clip data corresponding to the task from a plurality of pieces of clip data of the clipboard; and
provide the clipboard based on the clip data corresponding to the task via the display.

2. The electronic device of claim 1, wherein the clip data comprises the clip object related to designated content and contextual information related to the clip object, and
wherein the contextual information comprises at least one of: a type of the clip object, identification information of an application, a task being performed by the application, and/or contextual information related to a user at the time of clip operation.

3. The electronic device of claim 2, wherein the processor is configured to:
store the clip object in a clipboard of the memory; and
store and manage contextual information linked to the clip object in a database of the memory via a lookup table.

4. The electronic device of claim 1, wherein the processor is configured to:
analyze a context of an application currently being executed in the electronic device and/or a task being performed in the executed application based on machine learning, based on the detection of the second user input;
extract clip data based on contextual information corresponding to the context of the task; and
recommend the extracted clip data corresponding to the context of the task via the clipboard.

5. The electronic device of claim 1, wherein the processor is configured to:
synchronize the clipboard in a plurality of electronic devices connected to a user device group based on a user account; and
synchronize changes in the clipboard with another electronic device connected based on the user account in real time.

6. The electronic device of claim 1, wherein the processor is configured to analyze the context of the task based on at least one of: recent contents of a current execution screen, a currently focused execution screen among multiple execution screens based on multiple windows, and/or contextual information of the user.

7. The electronic device of claim 1, wherein the processor is configured to:
classify the extracted clip data based on each corresponding contextual information; and
provide the clipboard while comprising a corresponding sorting interface based on a result of the classification.

8. The electronic device of claim 1, wherein the processor is configured to:
detect a user input for pinning at least one piece of clip data to a designated area in the clipboard; and
pin and provide the at least one piece of clip data to the designated area in the clipboard based on the user input and provide the pinned clip data.

9. The electronic device of claim 1, wherein the processor is configured to:
identify a designated policy related to access to the clipboard in a case of calling the clipboard;
extract the clip data based on an account logged into the electronic device to provide the clipboard in a case that the designated policy is a first technique; and
extract clip data configured in a public manner to provide the clipboard in a case that the designated policy is a second technique.

10. The electronic device of claim 1, wherein the processor is configured to collectively or individually provide settings of at least one of: a public-based first policy, a login account-based second policy, or a third policy that is limited to a user account generating clip data, with respect to a plurality of pieces of clip data of the clipboard.

11. The electronic device of claim 1, wherein the processor is configured to, in a case that the electronic device detects logout of a user account, collectively hide the clip data generated based on the user account in the clipboard, within the clipboard.

12. The electronic device of claim 1, wherein the processor is configured to designate a sharing target of the clip data in the clipboard.

13. The electronic device of claim 1, wherein the processor is configured to:
detect a user input related to selection of at least one piece of clip data in the clipboard;
analyze contextual information of selected clip data based on the detection of the user input;
identify and execute an application associated with the clip data based on the contextual information; and
resume a user's task based on the clip data in the application.

14. The electronic device of claim 1, wherein the processor is configured to:
detect a user input related to movement of clip data;
identify a movement area in which a user input is moved based on the detection of the user input;
execute a first function of pasting the clip data in case that an area in which the clip data is moved is a first designated area; and
execute a second function of resuming a task based on the clip data in case that the area in which the clip data is moved is a second designated area.

15. An operation method of an electronic device, the operation method comprising:
detecting a first user input for a clip comprising designated content while displaying an execution screen of an application;
generating clip data comprising a clip object and contextual information related to the content based on the first user input and storing the generated clip data in a memory;
detecting a second user input related to a clipboard call;
analyzing a task currently being performed in the electronic device based on the detection of the second user input;
calling a clipboard based on the detection of the second user input;
extracting clip data corresponding to the task from among a plurality of pieces of clip data of the clipboard; and
providing a clipboard based on the clip data corresponding to the task via a display of the electronic device.
